(19) United States
(12) Patent Application Publication
(10) Pub. No.: US 2019/0152204 A1
(43) Pub. Date: May 23, 2019

(54) LAMINATED FILM AND POLARIZING PLATE

(71) Applicant: ZEON CORPORATION, Chiyoda-ku, Tokyo (JP)

(72) Inventor: Kyosuke INOUE, Tokyo (JP)

(73) Assignee: ZEON CORPORATION, Chiyoda-ku, Tokyo (JP)

(21) Appl. No.: 16/314,106

(22) PCT Filed: Jun. 28, 2017
(86) PCT No.: PCT/JP2017/023793

§ 371 Date: Dec. 28, 2018

(30) Foreign Application Priority Data
Jul. 7, 2016 (JP) 2016-135491

(51) Int. Cl. B32B 27/08; B32B 7/023; G02B 5/30

(52) U.S. Cl. CPC B32B 27/08; G02B 5/3083; G02B 5/3033; B32B 7/023

(57) ABSTRACT

A layered film includes first, second and third layers which are formed of first, second and third resins, respectively, and provided in this order. The second resin has a glass transition temperature that is lower than those of the first and third resins. The first and third resins have an indentation elastic modulus of 2200 MPa or more measured using a film of the first resin having a thickness of 100 μm; and a water vapor transmission rate of 5 g/m²·day or less measured in accordance with JIS K7129 B (1992) using a film of the first resin having a thickness of 100 μm. The layered film has a ratio of a sum of thicknesses of the first and third layers relative to a thickness of the second layer falling within a range of 1 or more and 4 or less.

### FIELD

The present invention relates to a layered film and a polarizing plate including the layered film.

### BACKGROUND

Some polarizing plates include a polarizer and an optical film for protecting the polarizer. As the optical film, there has been proposed a layered film having a three-layer structure in which surface layers are laminated on both sides of an intermediate layer (for example, see Patent Literatures 1 and 2). When the optical film is a layered film having a three-layer structure, the material constituting an intermediate layer can contain an additive which the material constituting surface layers cannot contain in a favorable manner (in the examples illustrated in Patent Literatures 1 and 2, an ultraviolet absorber).

In recent years, there is a demand for an increased amount of an additive in the intermediate layer of the layered film having a three-layer structure so that the function exerted by the additive is enhanced. However, it has been commonly understood by those skilled in the art that the upper limit of the concentration of the additive in the intermediate layer is limited. Consequently, thickening the intermediate layer for increasing the amount of an additive has become recent technical common knowledge.

### CITATION LIST

### Patent Literature

Patent Literature 1: Japanese Patent Application Laid-Open No. 2015-031753 A

Patent Literature 2: Japanese Patent Application Laid-Open No. 2011-203400

### SUMMARY

### Technical Problem

However, the glass transition temperature of the intermediate layer tends to decrease as the amount of an additive in a material constituting the intermediate layer increases. Therefore, the glass transition temperature of the intermediate layer is lower than the glass transition temperature of the surface layers in the layered film, even when the intermediate layer and the surface layers are formed of a resin containing an identical polymer.

As a result, when a certain amount of an additive is ensured in the intermediate layer, the intermediate layer having a low glass transition temperature becomes thick, and the surface layers having a high glass transition temperature become thin. Accordingly, the heat resistance as the entire layered film has deteriorated.

Therefore, an object of the present invention is to provide: a layered film having excellent heat resistance which can solve the aforementioned problem; and a polarizing plate including the layered film.

### Solution to Problem

The present inventor conducted researches for solving the aforementioned problem, particularly, relating to a layered film that includes a second layer formed of a resin having a relatively low glass transition temperature and first and third layers formed of a resin having a relatively high glass transition temperature disposed on both surfaces of the second layer. Specifically, research was conducted on a resin to be adopted as the first and third layers of the layered film and the thickness relationship between the first and third layers and the second layer. As a result, the present inventor has found that when the layered film adopts a resin having specific properties as the resin constituting the first and third layers, and the ratio of the sum of the thicknesses of the first and third layers relative to the thickness of the second layer falls within a specific range, the problem attributable to the low glass transition temperature of the second layer can be solved to provide a layered film having excellent heat resistance. The present invention has been achieved on the basis of such findings.

That is, the present invention is as follows.

(1) A layered film comprising a first layer formed of a first resin, a second layer formed of a second resin, and a third layer formed of a third resin, which are provided in this order, wherein

the second resin has a glass transition temperature that is lower than a glass transition temperature of the first resin and lower than a glass transition temperature of the third resin,

the first resin has an indentation elastic modulus of 2200 MPa or more, the indentation elastic modulus being measured using a film of the first resin having a thickness of 100 μm,

the third resin has an indentation elastic modulus of 2200 MPa or more, the indentation elastic modulus being measured using a film of the third resin having a thickness of 100 μm,

the first resin has a water vapor transmission rate of 5 g/m²·day or less, the water vapor transmission rate being measured in accordance with JIS K7129 B (1992) using a film of the first resin having a thickness of 100 μm,

the third resin has a water vapor transmission rate of 5 g/m²·day or less, the water vapor transmission rate being measured in accordance with JIS K7129 B (1992) using a film of the third resin having a thickness of 100 μm, and the layered film has a ratio of a sum of a thickness of the first layer and a thickness of the third layer relative to a thickness of the second layer falling within a range of 1 or more and 4 or less.

(2) The layered film according to (1), wherein one or both of the first resin and the third resin have an impact strength of 3×10⁻² J or more, the impact strength being measured using a film thereof having a thickness of 100 μm.

(3) The layered film according to (1) or (2), wherein the glass transition temperatures of one or both of the first resin and the third resin are 150° C. or higher.

(4) The layered film according to any one of (1) to (3), wherein the layered film has a thickness of 50 μm or less.

(5) The layered film according to any one of (1) to (4), wherein one or both of the first resin and the third resin contain a polymer having an alicyclic structure.

(6) The layered film according to any one of (1) to (5), wherein the second resin contains a polymer having an alicyclic structure.

(7) The layered film according to any one of (1) to (6), having a light transmittance at a wavelength of 380 nm being 3% or less.

(8) A polarizing plate comprising a polarizer and the layered film according to any one of (1) to (7).

### Advantageous Effects of Invention

The present invention can achieve a layered film having excellent heat resistance; and a polarizing plate including the layered film.

### BRIEF DESCRIPTION OF DRAWINGS

FIG. 1 is a cross-sectional view schematically illustrating an optical layered body according to an embodiment of the present invention.

FIG. 2 is a cross-sectional view schematically illustrating a polarizing plate according to an embodiment of the present invention.

FIG. 3 is a perspective view illustrating a measurement method of the impact strength of a film in the present application.

FIG. 4 is a cross-sectional view illustrating a measurement method of the impact strength of a film in the present application.

### DESCRIPTION OF EMBODIMENTS

Hereinafter, the present invention will be described in detail with reference to embodiments and examples. However, the present invention is not limited to the following embodiments and examples, and may be freely modified for implementation without departing from the scope of claims of the present invention and the scope of their equivalents.

In the following description, a retardation represents an in-plane retardation, unless otherwise specified. An in-plane retardation Re of a film is a value represented by Re=(nx−ny)×d, unless otherwise specified. Herein, nx represents a refractive index in a direction in which the maximum refractive index is given among directions perpendicular to the thickness direction of the film (in-plane directions), ny represents a refractive index in a direction, among the above-mentioned in-plane directions of the film, orthogonal to the direction giving nx, and d represents the thickness of the film. The measurement wavelength of the retardation is 550 nm unless otherwise specified.

In the following description, a slow axis of a film refers to a slow axis in a surface of the film, unless otherwise specified.

In the following description, “¼ wave plate” and “polarizing plate” include not only a rigid member but also a flexible member, for example, a resin film, unless otherwise specified.

In the following description, a “long-length” film refers to a film with the length that is usually 5 times or more the width, and preferably a film with the length that is 10 times or more the width, and specifically refers to a film having a length that allows a film to be wound up into a rolled shape for storage or transportation. The upper limit of the length thereof is not particularly limited, but is usually 100,000 times or less the width.

In the following description, “ultraviolet rays” refers to light having a wavelength of 10 nm or more and less than 400 nm, unless otherwise specified, and “visible light” refers to light having a wavelength of 400 nm or more and 700 nm or less, unless otherwise specified.

In the following description, the angle formed between the optical axis (polarized light transmission axis, slow axis, and the like) of each film in a member including a plurality of films and a specific in-plane direction of the film represents an angle when the film is viewed from the thickness direction, unless otherwise specified.

[1. Summary of Layered Film]

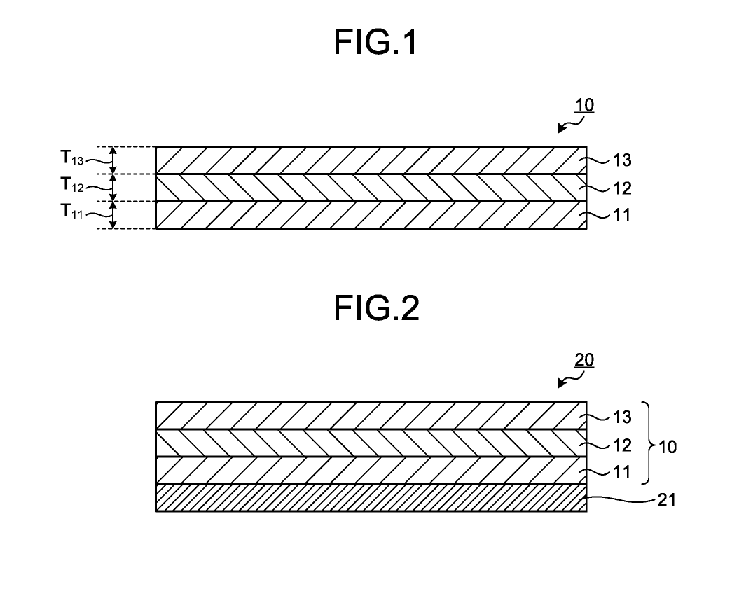

FIG. 1 is a cross-sectional view schematically illustrating a layered film 10 according to an embodiment of the present invention.

As illustrated in FIG. 1, the layered film 10 includes a first layer 11, a second layer 12, and a third layer 13 in this order. Therefore, the second layer 12 is disposed between the first layer 11 and the third layer 13.

In the layered film 10, the first layer 11 and the second layer 12 are usually in direct contact with each other without another layer interposed therebetween, and the second layer 12 and the third layer 13 are usually in direct contact with each other without another layer therebetween. Therefore, the second layer 12 is an intermediate layer with the first layer 11 and the third layer 13 serving as an outer layer in the layered film 10.

In this manner, the layered film 10 has a structure including three or more layers. Therefore, the material constituting the second layer 12 can contain an additive which is difficult to be contained in the material constituting the first layer 11 and the material constituting the third layer 13. This is because the first layer 11 and the third layer 13 serving as the outer layer suppress the bleed-out of the additive contained in the material of the second layer 12.

For example, an ultraviolet absorber as an additive can be contained in the material constituting the second layer 12. When an ultraviolet absorber is used as an additive, the layered film 10 can suppress the transmission of ultraviolet rays. In this manner, depending on the type of an additive contained in the material of the second layer 12, the layered film 10 can exert the function possessed by the additive.

The layered film 10 is formed of a resin. Specifically, the first layer 11 is formed of a first resin (A), the second layer 12 is formed of a second resin (B), and the third layer 13 is formed of a third resin (C). The second resin (B) has a glass transition temperature that is lower than that of the first resin (A), and lower than that of the third resin (C). As described herein, the “glass transition temperature” refers to, when a resin constituting each layer contains a plurality of components, the glass transition temperature of the entire resin. Therefore, the heat resistance of the second layer 12 usually tends to be inferior to that of the first layer 11, and also inferior to that of the third layer 13. These tendencies are more significant as the amount of an additive contained in the material of the second layer 12 is larger. Herein, in general as to a layered film having a three-layer structure, even if an intermediate layer having a relatively inferior heat resistance is placed between outer layers having excellent heat resistance, the entire layered film is not necessarily excellent in heat resistance. Furthermore, the heat resistance tends to decrease as the second layer 12 is thicker. However, according to the present invention, the layered film 10 can be excellent in heat resistance, as demonstrated in Examples.

Usually, the layered film 10 has high transparency, that is, low haze, and has high total light transmittance, that is, high visible light transmittance. Therefore, the layered film 10 may be used as an optical film. Such an optical film may be used as a protective film for a polarizer. That is, the layered film 10 may be used as a member of a polarizing plate. Therefore, it is preferable that the layered film 10 is excellent in low moisture permeability. Furthermore, a polarizing plate including the layered film 10 may be used as a member of an image display device.

A description will be given hereinbelow of respective components of the layered film 10.

[2. First Layer]

As described above, the first layer 11 is formed of the first resin (A). The first resin (A) has an indentation elastic modulus of 2200 MPa or more, wherein the indentation elastic modulus is measured using a film of the first resin (A) having a thickness of 100 μm. Thereby, the layered film 10 can have excellent rigidity. The first resin (A) has a water vapor transmission rate of 5 g/m²·day or less, wherein the water vapor transmission rate is measured in accordance with JIS K7129 B (1992) using a film of the first resin (A) having a thickness of 100 μm. Thereby, the layered film 10 can have excellent low moisture permeability. When a resin satisfying these properties is adopted as the first resin (A), the layered film 10 can have excellent heat resistance even if the layered film 10 has the second resin (B) having a relatively low glass transition temperature. Instead of performing measurement in accordance with JIS K7129 B (1992), measurement of the water vapor transmission rate may also be performed in accordance with JIS K 7129 (2008), ISO 15106-1 (2003), or ISO 15106-2 (2003) after confirming the equivalence of the measured results.

The thickness of the first layer 11 (T₁₁ shown in FIG. 1) is preferably 5 μm or more, more preferably 8 μm or more, and particularly preferably 10 μm or more, and is preferably 20 μm or less, more preferably 18 μm or less, and particularly preferably 15 μm or less. When the thickness of the first layer 11 is equal to or more than the lower limit value of the aforementioned range, bleed-out of additives that may be contained in the second layer 12 can be effectively suppressed. When the thickness of the first layer 11 is equal to or less than the upper limit value of the aforementioned range, the thickness of the second layer 12 is increased. Therefore, the amount of the additive in the material constituting the second layer 12 can be increased, so that the function exerted by the additive can be enhanced in the layered film 10. The thickness may be measured or calculated as described in the section of the evaluation items in Examples. Alternatively, the thickness may be measured by the following method. The layered film 10 is embedded with an epoxy resin, and a sample piece is prepared. This sample piece is sliced using a microtome to obtain a sliced piece having a thickness of 0.05 μm. After that, the cross section appeared on the sliced piece is observed using a microscope.

From the viewpoint of the suppression of bleed-out, it is preferable that the first resin (A) does not contain an additive. That is, it is preferable that the first resin (A) is formed of a resin not containing an additive. The first resin (A) is usually a thermoplastic resin. Therefore, the first resin (A) usually contains a thermoplastic polymer.

As the thermoplastic polymer, a polymer satisfying the aforementioned properties is used. As the polymer constituting the first resin (A), one type thereof may be solely used, and two or more types thereof may also be used in combination at any ratio. The polymer may be a homopolymer or a copolymer.

In view of excellent mechanical properties, heat resistance, transparency, low hygroscopicity, low moisture permeability, size stability, and light weight properties, a polymer (A1) containing an alicyclic structure (also referred to as an alicyclic cyclic structure) is preferably used as the polymer constituting the first resin (A). Herein, the mechanical properties are a generic term of dynamic properties including rigidity (indentation elasticity), impact resistance, and tensile elasticity.

The polymer (A1) containing an alicyclic structure is a polymer of which the structural unit contains an alicyclic structure. The polymer (A1) containing an alicyclic structure usually has excellent moisture and heat resistance. Therefore, when polymer (A1) containing an alicyclic structure is used, the moisture and heat resistance of the layered film 10 can be improved.

The polymer (A1) containing an alicyclic structure may have an alicyclic structure in the main chain and may have an alicyclic structure in the side chain, and both the main chain and side chain thereof may have an alicyclic structure. Among these, from the viewpoint of mechanical strength and heat resistance, a polymer containing an alicyclic structure in at least the main chain is preferable.

Examples of the alicyclic structure may include a saturated alicyclic hydrocarbon (cycloalkane) structure, and an unsaturated alicyclic hydrocarbon (cycloalkene, cycloalkyne) structure. Among these, a cycloalkane structure and a cycloalkene structure are preferable from the viewpoint of mechanical strength and heat resistance. A cycloalkane structure is particularly preferable among these.

The number of carbon atoms constituting the alicyclic structure is preferably 4 or more, and more preferably 5 or more, and is preferably 30 or less, more preferably 20 or less, and particularly preferably 15 or less, per alicyclic structure. When the number of carbon atoms constituting the alicyclic structure falls within this range, mechanical strength, heat resistance, and moldability of the resin including the polymer (A1) containing an alicyclic structure are highly balanced.

The ratio of the structural unit having an alicyclic structure in the polymer (A1) containing an alicyclic structure is appropriately selected in accordance with its purpose of use. The ratio of the structural unit having an alicyclic structure in the polymer (A1) containing an alicyclic structure is preferably 55% by weight or more, more preferably 70% by weight or more, and particularly preferably 90% by weight or more. When the ratio of the structural unit having an alicyclic structure in the polymer (A1) containing an alicyclic structure falls within this range, the first resin (A) has good transparency and heat resistance.

Examples of the polymer (A1) containing an alicyclic structure may include a norbornene-based polymer, a monocyclic cyclic olefin-based polymer, a cyclic conjugated diene-based polymer, a vinyl alicyclic hydrocarbon polymer, and hydrogenated products thereof. Among these, a norbornene-based polymer is more preferable because of good transparency and moldability.

Examples of the norbornene-based polymer may include a ring-opening polymer of a monomer having a norbornene structure and a hydrogenated product thereof; and an addition polymer of a monomer having a norbornene structure and a hydrogenated product thereof. Examples of the ring-opening polymer of a monomer having a norbornene structure may include a ring-opening homopolymer of one type of monomer having a norbornene structure, a ring-opening copolymer of two or more types of monomers having a norbornene structure, and a ring-opening copolymer of a monomer having a norbornene structure and an optional monomer copolymerizable therewith. Examples of the addition polymer of a monomer having a norbornene structure may include an addition homopolymer of one type of monomer having a norbornene structure, an addition copolymer of two or more types of monomers having a norbornene structure, and an addition copolymer of a monomer having a norbornene structure and an optional monomer copolymerizable therewith. Among these, a hydrogenated product of a ring-opening polymer of a monomer having a norbornene structure is particularly suitable from the viewpoint of moldability, heat resistance, low hygroscopicity, low moisture permeability, size stability, and light weight properties.

Examples of the monomer having a norbornene structure may include bicyclo[2.2.1]hept-2-ene (common name: norbornene), tricyclo[4.3.0.1^{2,5}]deca-3,7-diene (common name: dicyclopentadiene), 7,8-benzotricyclo[4.3.0.1^{2,5}]dec-3-ene (common name: methanotetrahydrofluorene), tetracyclo[4.4.0.1^{2,5}.1^{7,10}]dodeca-3-ene (common name: tetracyclododecene), and derivatives of these compounds (for example, those with a substituent on the ring). Examples of the substituent may include an alkyl group, an alkylene group, and a polar group. These substituents may be the same as or different from each other, and a plurality of these substituents may be bonded to the ring. As the monomer having a norbornene structure, one type thereof may be solely used, and two or more types thereof may also be used in combination at any ratio.

Examples of the polar group may include a heteroatom, and an atomic group having a heteroatom. Examples of the heteroatom may include an oxygen atom, a nitrogen atom, a sulfur atom, a silicon atom, and a halogen atom. Specific examples of the polar group may include a carboxyl group, a carbonyloxycarbonyl group, an epoxy group, a hydroxyl group, an oxy group, an ester group, a silanol group, a silyl group, an amino group, a nitrile group, and a sulfonic acid group.

Examples of a monomer that is ring-opening copolymerizable with the monomer having a norbornene structure may include monocyclic olefins such as cyclohexene, cycloheptene, and cyclooctene, and derivatives thereof; and cyclic conjugated dienes such as cyclohexadiene and cycloheptadiene, and derivatives thereof. As the monomer that is ring-opening copolymerizable with the monomer having a norbornene structure, one type thereof may be solely used, and two or more types thereof may also be used in combination at any ratio.

The ring-opening polymer of the monomer having a norbornene structure may be produced, for example, by polymerizing or copolymerizing the monomer in the presence of a ring-opening polymerization catalyst.

Examples of a monomer that is addition copolymerizable with the monomer having a norbornene structure may include α-olefins of 2 to 20 carbon atoms such as ethylene, propylene, and 1-butene, and derivatives thereof; cycloolefins such as cyclobutene, cyclopentene, and cyclohexene, and derivatives thereof; and non-conjugated dienes such as 1,4-hexadiene, 4-methyl-1,4-hexadiene, and 5-methyl-1,4-hexadiene. Among these, α-olefin is preferable, and ethylene is more preferable. As the monomer that is addition copolymerizable with the monomer having a norbornene structure, one type thereof may be solely used, and two or more types thereof may also be used in combination at any ratio.

The addition polymer of the monomer having a norbornene structure may be produced, for example, by polymerizing or copolymerizing the monomer in the presence of an addition polymerization catalyst.

The above-mentioned hydrogenated products of the ring-opening polymer and the addition polymer may be produced, for example, by hydrogenating an unsaturated carbon-carbon bond, preferably 90% or more thereof, in a solution of the ring-opening polymer and the addition polymer in the presence of a hydrogenation catalyst containing a transition metal such as nickel, palladium, or the like.

Among the norbornene-based polymers, it is preferable that the polymer has an X: bicyclo[3.3.0]octane-2,4-diyl-ethylene structure and a Y: tricyclo[4.3.0.1^{2,5}]decane-7,9-diyl-ethylene structure as structural units, and that the amount of these structural units is 90% by weight or more relative to the entire structural unit of the norbornene-based polymer, and the ratio of X and Y is 100:0 to 40:60 by weight ratio of X:Y. By using such a polymer, the first layer 11 containing the norbornene-based polymer can have excellent stability of optical properties without size change over a long period of time.

The weight-average molecular weight (Mw) of the polymer (A1) containing an alicyclic structure is preferably 10,000 or more, more preferably 15,000 or more, and particularly preferably 20,000 or more, and is preferably 100,000 or less, more preferably 80,000 or less, and particularly preferably 50,000 or less. When the weight-average molecular weight falls within this range, mechanical strength and moldability of the first layer 11 are highly balanced.

The molecular weight distribution (Mw/Mn) of the polymer (A1) containing an alicyclic structure is preferably 1.2 or more, more preferably 1.5 or more, and particularly preferably 1.8 or more, and is preferably 3.5 or less, more preferably 3.0 or less, and particularly preferably 2.7 or less. Herein, Mn represents the number-average molecular weight. When the molecular weight distribution is equal to or more than the lower limit value of the aforementioned range, the productivity of the polymer can be increased and the production cost can be suppressed. When the molecular weight distribution is equal to or less than the upper limit value thereof, the amount of the low molecular weight component is small, and the relaxation at the time of high temperature exposure can be suppressed, whereby the stability of the first layer 11 can be enhanced.

The weight-average molecular weight (Mw) and the number-average molecular weight (Mn) may be measured by gel permeation chromatography (GPC). Examples of the solvent used in GPC may include cyclohexane, toluene, and tetrahydrofuran. In the case of using GPC, the weight-average molecular weight is measured as a polyisoprene-equivalent or polystyrene-equivalent relative molecular weight, for example.

The amount of the polymer (A1) containing an alicyclic structure in the first resin (A) is preferably 84% by weight or more, more preferably 86% by weight or more, and particularly preferably 90% by weight or more, and is preferably 95% by weight or less, more preferably 93% by weight or less, and particularly preferably 92% by weight or less. The remainder may be composed of components selected from other polymers and optional additives. When the amount of the polymer (A1) containing an alicyclic structure falls within the aforementioned range, moisture and heat resistance and mechanical properties of the layered film 10 can be effectively improved. Therefore, when the layered film 10 is used as a protective film for a polarizer, the durability of the polarizing plate under humidified conditions can be enhanced.

Subsequently, the properties required of the first resin (A) will be described.

The indentation elastic modulus of the first resin (A) in terms of the measurement value using a film of the first resin (A) having a thickness of 100 μm is 2200 MPa or more, more preferably 2350 MPa or more, and particularly preferably 2500 MPa or more, and is preferably 4500 MPa or less, more preferably 3500 MPa or less, and particularly preferably 3000 MPa or less. When the indentation elastic modulus is equal to or more than the lower limit value, the first layer 11, and in turn, the layered film 10 can have sufficiently excellent rigidity. When the indentation elastic modulus is equal to or less than the upper limit value, flexibility of the first layer 11 can be ensured. The indentation elastic modulus may be measured using a commercially available indentation elastic modulus tester, and may be specifically measured as described in the section of the evaluation items in Examples.

The water vapor transmission rate of the first resin (A) in terms of the measurement value measured in accordance with JIS K7129 B (1992) using a film of the first resin (A) having a thickness of 100 μm is 5 g/m²·day or less, and particularly preferably 1 g/m²·day or less. The lower limit thereof is ideally zero, and may be 0.1 g/m²·day. When the water vapor transmission rate is equal to or less than the upper limit value, the first layer 11, and in turn, the layered film 10 can have sufficiently excellent low moisture permeability. The water vapor transmission rate may be measured using a commercially available water vapor permeability measuring device, and may be specifically measured as described in the section of the evaluation items in Examples. In consideration of the use applications of the layered film 10, the measurement condition is preferably at least the humidification condition of a temperature of 40° C. and a humidity of 90% RH.

The impact strength of the first resin (A) in terms of the measurement value using a film of the first resin (A) having a thickness of 100 μm is preferably 3×10⁻² J or more, more preferably 5×10⁻² J or more, and particularly preferably 8×10⁻² J or more. When the impact strength is equal to or more than the lower limit value, the first layer 11, and in turn, the layered film 10 can reliably have excellent rigidity. The upper limit of the impact strength is not limited, and may be, for example, 20×10⁻² J or less. The impact strength may be measured by performing an impact test to a film fixed with a jig using a specific striker. In consideration of the fact that the film is thin, the impact strength is preferably measured as described in the section of the evaluation items in Examples, without using a commercially available impact tester.

The glass transition temperature of the first resin (A) is preferably 150° C. or higher, and more preferably 160° C. or higher, and is preferably 200° C. or lower, more preferably 180° C. or lower, and particularly preferably 170° C. or lower. When the glass transition temperature of the first resin (A) is equal to or more than the lower limit value of the aforementioned range, durability of the layered film 10 in a high temperature environment can be enhanced. When the glass transition temperature is equal to or less than the upper limit value of the aforementioned range, the stretching treatment of the layered film 10 can be facilitated. The glass transition temperature may be measured using, for example, a commercially available differential scanning calorimeter.

The tensile elastic modulus of the first resin (A) in terms of the measurement value using a film of the first resin (A) having a thickness of 100 μm is preferably 2000 MPa or more, more preferably 2300 MPa or more, and particularly preferably 2500 MPa or more, and is preferably 4500 MPa or less, more preferably 3500 MPa or less, and particularly preferably 3000 MPa or less. When the tensile elastic modulus is equal to or more than the lower limit value, rigidity of the first layer 11, and in turn, tensile elasticity of the layered film 10 can be sufficiently elevated to an excellent level. When the tensile elastic modulus is equal to or less than the upper limit value, flexibility of the first layer 11 can be ensured. The tensile elastic modulus may be measured using a commercially available tensile tester, and may be specifically measured as described in the section of the evaluation items in Examples.

The refractive index of the first resin (A) in terms of the measurement value using a film of the first resin (A) having a thickness of 100 μm is preferably 1.45 or more, more preferably 1.48 or more, and particularly preferably 1.50 or more, and is preferably 1.60 or less, more preferably 1.58 or less, and particularly preferably 1.54 or less. When the refractive index of the first resin (A) falls within the aforementioned range, a difference in the refractive index between the layered film 10 and a polarizer for which the layered film 10 is used as a protective film can be easily reduced. Accordingly, the transmittance of the polarizing plate can be increased.

The saturated water absorption rate of the first resin (A) in terms of the measurement value measured in accordance with JIS K7129 B (1992) using a film of the first resin (A) having a thickness of 100 μm is preferably 0.03% by weight or less, further preferably 0.02% by weight or less, and particularly preferably 0.01% by weight or less. When the saturated water absorption rate falls within the aforementioned range, time-dependent change of the optical properties such as a retardation of the first layer 11 can be reduced. Also, when the layered film 10 is used as the protective film for a polarizer, deterioration of the polarizing plate and the image display device can be suppressed. Accordingly, displaying performance of the image display device can be maintained stable and favorable over a long period of time.

The saturated water absorption rate is a value expressed in percentage of an increased weight obtained by immersing a sample in water at a certain temperature for a certain period, relative to the weight of a test piece before the immersion. The saturated water absorption rate is usually measured by immersing the sample in water at 23° C. for 24 hours. The saturated water absorption rate of the first resin (A) may be adjusted within the aforementioned range by, for example, reducing the amount of a polar group in the constituent polymer. Therefore, from the viewpoint of lowering the saturated water absorption rate, it is preferable that the polymer constituting the first resin (A) does not have a polar group.

The absolute value of the photoelastic coefficient of the first resin (A) is preferably 10×10⁻¹² Pa⁻¹ or less, more preferably 7×10⁻¹² Pa⁻¹ or less, and particularly preferably 4×10⁻¹² Pa⁻¹ or less. When the absolute value of the photoelastic coefficient of the first resin (A) falls within the aforementioned range, the layered film 10 having high optical performance can be easily produced. Also, when the layered film 10 is a stretched film, fluctuation of the in-plane retardation Re can be reduced. The photoelastic coefficient C is represented by the value of the ratio of birefringence Δn relative to stress σ (that is, C=Δn/σ).

[3. Second Layer]

As previously described, the second layer 12 is formed of the second resin (B). The second resin (B) is usually a thermoplastic resin containing an optional additive. Therefore, the second resin (B) usually contains a thermoplastic polymer and an optional additive. Herein, the additive refers to a material added for a specific purpose, and preferably refers to a material added for the purpose of exerting the function in the layered film 10.

The thickness of the second layer 12 (T₁₂ shown in FIG. 1) is preferably 5 μm or more, more preferably 8 μm or more, and particularly preferably 10 μm or more, and is preferably 40 μm or less, more preferably 35 μm or less, and particularly preferably 30 μm or less. When the thickness of the second layer 12 falls within this range, the additive can be contained in an amount sufficient for exerting the function in the layered film 10 while ensuring the heat resistance of the layered film 10.

As previously described, the second resin (B) has the glass transition temperature that is lower than the glass transition temperature of the first resin (A), and lower than the glass transition temperature of the third resin (C). That is, a resin having heat resistance lower than the heat resistance required of the first resin (A) may be used as the second resin (B). This is because, as long as the heat resistance of the first layer 11 and the heat resistance of the third layer 13 are sufficiently excellent, the heat resistance of the second layer 12 disposed therebetween does not need to be high to an extent that is required of the first layer 11 and the third layer 13. In other words, the low heat resistance of the second layer 12 is compensated with the sufficiently excellent heat resistance of the first layer 11 and the third layer 13. Therefore, when the degree of the heat resistance required of the layered film 10 is previously determined, the degree of the low heat resistance, that is, the lower limit value of the glass transition temperature, of the second layer 12 is determined depending on the degree of the heat resistance of the first layer 11 and the degree of the heat resistance of the third layer 13.

Further, if the properties other than heat resistance of the second layer 12 can be compensated with the properties of the first layer 11 and the properties of the third layer 13, a resin having properties inferior to those of the first resin (A) and the third resin (C) may be used as the second resin (B) constituting the second layer 12. Examples of such properties may include rigidity (indentation elasticity) and impact strength.

It is preferable to use as the second resin (B) a resin containing a polymer that is of the same type as the type of the polymer constituting the first resin (A) and an optional additive. It is also preferable to use as the second resin (B) a resin containing a polymer and an optional additive, wherein the polymer is of a different type from the type of the polymer constituting the first resin (A), although the polymer has the same degree of tensile modulus as the polymer constituting the first resin (A). When the second resin (B) contains an additive, the glass transition temperature is usually lower than the glass transition temperature of the first resin (A). Furthermore, when the second resin (B) contains an additive, the function possessed by the additive can also be exerted in the layered film 10.

As the polymer contained in the second resin (B), a polymer satisfying the aforementioned properties is used. As the polymer that may constitute the second resin (B), one type thereof may be solely used, and two or more types thereof may also be used in combination at any ratio. The polymer may be a homopolymer or a copolymer.

As the polymer contained in the second resin (B), a polymer (B1) belonging to the aforementioned polymer (A1) containing an alicyclic structure is preferably used. However, since the polymer (B1) and the polymer (A1) containing an alicyclic structure are polymers, they are usually not a completely identical compound. Therefore, they may be different in polymerization degrees, hydrogenation rates, ratios of structural units having an alicyclic structure, and the like. Accordingly, the same advantage as that having been described for the polymer of the first resin (A) can be obtained. Also, the increase of the adhesion strength between the second layer 12 and the first layer 11 as well as the suppression of light reflection at the interface between the second layer 12 and the first layer 11 are facilitated.

Instead of this, it is also preferable to use as the polymer constituting the second resin (B) a polymer (B2) having an aromatic vinyl compound hydrogenated product unit (a) and a chain conjugated diene compound hydrogenated product unit (b).

The polymer (B2) having an aromatic vinyl compound hydrogenated product unit (a) and a chain conjugated diene compound hydrogenated product unit (b) is obtained by hydrogenating a polymer having an aromatic vinyl compound unit and a chain conjugated diene compound unit. The aromatic vinyl compound unit is a structural unit having a structure formed by polymerizing an aromatic vinyl compound. The chain conjugated diene compound unit is a structural unit having a structure formed by polymerizing a chain conjugated diene compound.

As the polymer (B2) having an aromatic vinyl compound hydrogenated product unit (a) and a chain conjugated diene compound hydrogenated product unit (b), a hydrogenated product (B2b) obtained by hydrogenating a specific block copolymer (B2a) is preferable.

The aforementioned specific block copolymer (B2a) has two or more polymer blocks [I] per molecule of the copolymer and one or more polymer blocks [II] per molecule of the copolymer.

The polymer block [I] contains an aromatic vinyl compound unit as a main component. In addition, the polymer block [II] contains a chain conjugated diene compound unit as a main component.

When the copolymer (B2a) is hydrogenated, the aromatic vinyl compound unit contained in the polymer block [I] becomes the aromatic vinyl compound hydrogenated product unit (a) of the polymer (B2). Likewise, when the copolymer (B2a) is hydrogenated, the chain conjugated diene compound unit contained in the polymer block [II] becomes the chain conjugated diene compound hydrogenated product unit (b) of the polymer (B2).

Any of these block copolymer (B2a) and the hydrogenated product (B2ba) thereof may be modified with, for example, an alkoxysilane, a carboxylic acid, a carboxylic acid anhydride, and the like.

Hereinafter, this specific block copolymer (B2a) and the hydrogenated product (B2b) thereof will be described in more detail.

[Specific Block Copolymer (B2a)]

As described above, the polymer block [I] that the specific block copolymer (B2a) contains has an aromatic vinyl compound unit. Examples of the aromatic vinyl compound corresponding to the aromatic vinyl compound unit in this polymer block [I] may include styrene, α-methylstyrene, 2-methylstyrene, 3-methylstyrene, 4-methylstyrene, 2,4-diisopropylstyrene, 2,4-dimethylstyrene, 4-t-butylstyrene, 5-t-butyl-2-methylstyrene, 4-monochlorostyrene, dichlorostyrene, 4-monofluorostyrene, and 4-phenylstyrene. One type thereof may be solely used, and two or more types thereof may also be used in combination at any ratio. Among these, those containing no polar group are preferable in terms of low hygroscopicity. Styrene is particularly preferable from the viewpoint of industrial availability and high impact strength.

The content ratio of the aromatic vinyl compound unit in the polymer block [I] is preferably 90% by weight or more, more preferably 95% by weight or more, and still more preferably 99% by weight or more. When the amount of the aromatic vinyl compound unit in the polymer block [I] is increased as described above, heat resistance of the second resin (B) can be enhanced.

The polymer block [I] may contain an optional structural unit other than the aromatic vinyl compound unit. Examples of the optional structural unit may include a chain conjugated diene compound unit, and a structural unit having a structure formed by polymerizing a vinyl compound other than the aromatic vinyl compound.

Examples of the chain conjugated diene compound corresponding to the chain conjugated diene compound unit may include the same examples as those exemplified as the examples of the chain conjugated diene compound corresponding to the chain conjugated diene compound unit of the polymer block [II]. As the chain conjugated diene compound, one type thereof may be solely used, and two or more types thereof may also be used in combination at any ratio.

Examples of the vinyl compound other than the aromatic vinyl compound may include a chain vinyl compound; a cyclic vinyl compound; a vinyl compound having a nitrile group, an alkoxycarbonyl group, a hydroxycarbonyl group, or a halogen group; an unsaturated cyclic acid anhydride; and an unsaturated imide compound. Among these, chain olefins such as ethylene, propylene, 1-butene, 1-pentene, 1-hexene, 1-heptene, 1-octene, 1-nonene, 1-decene, 1-dodecene, 1-eicosene, 4-methyl-1-pentene, and 4,6-dimethyl-1-heptene; and cyclic olefins such as vinylcyclohexane, which do not contain a polar group, are preferable in terms of low hygroscopicity. Among these, a chain olefin is more preferable, and ethylene and propylene are particularly preferable. One type thereof may be solely used, and two or more types thereof may also be used in combination at any ratio.

The content ratio of the optional structural unit in the polymer block [I] is preferably 10% by weight or less, more preferably 5% by weight or less, and further more preferably 1% by weight or less.

The number of the polymer blocks [I] in one molecule of the block copolymer is preferably 2 or more, and is preferably 5 or less, more preferably 4 or less, and further more preferably 3 or less. A plurality of polymer blocks [I] in one molecule may be the same as or different from each other.

When a plurality of different polymer blocks [I] are present in one molecule of the block copolymer, the weight-average molecular weight of a polymer block having a maximum weight-average molecular weight in the polymer block [I] is represented by Mw([I]max), and the weight-average molecular weight of a polymer block having a minimum weight-average molecular weight is represented by Mw([I]min). In this case, the ratio

“Mw([I]max)/Mw([I]min)” that is a ratio of Mw([I]max) relative to Mw([I]min) is preferably 2.0 or less, more preferably 1.5 or less, and particularly preferably 1.2 or less. By having such a ratio, fluctuations in various property values can be reduced.

On the other hand, the polymer block [II] that the specific block copolymer (B2a) contains has a chain conjugated diene compound unit. Examples of the chain conjugated diene compound corresponding to the chain conjugated diene compound unit of this polymer block [II] may include 1,3-butadiene, isoprene, 2,3-dimethyl-1,3-butadiene, and 1, 3-pentadiene. One type thereof may be solely used, and two or more types thereof may also be used in combination at any ratio. Among these, those containing no polar group are preferable in terms of low hygroscopicity, and 1,3-butadiene and isoprene are particularly preferable.

The content ratio of the chain conjugated diene compound unit in the polymer block [II] is preferably 90% by weight or more, more preferably 95% by weight or more, and further more preferably 99% by weight or more. When the amount of the chain conjugated diene compound unit is increased in the polymer block [II] as described above, impact strength of the second resin (B) at low temperatures can be improved.

The polymer block [II] may contain an optional structural unit other than the chain conjugated diene compound unit. Examples of the optional structural units may include an aromatic vinyl compound unit and a structural unit having a structure formed by polymerizing a vinyl compound other than aromatic vinyl compounds. Examples of the aromatic vinyl compound unit and the structural unit having a structure formed by polymerizing a vinyl compound other than the aromatic vinyl compound may include those exemplified as those which may be contained in the polymer block [I].

The content ratio of the optional structural unit in the polymer block [II] is preferably 10% by weight or less, more preferably 5% by weight or less, and further more preferably 1% by weight or less. In particular, when the content ratio of the aromatic vinyl compound unit in the polymer block [II] is lowered, flexibility of the second resin (B) at low temperatures can be improved, and thereby impact strength of the second resin (B) at low temperatures can be improved.

The number of the polymer blocks [II] in one molecule of the block copolymer is usually 1 or more, but may be 2 or more. When the number of the polymer blocks [II] in the block copolymer is 2 or more, the polymer blocks [II] may be the same as or different from each other.

When a plurality of different polymer blocks [II] are present in one molecule of the block copolymer, the weight-average molecular weight of a polymer block having a maximum weight-average molecular weight in the polymer block [II] is represented by Mw([II]max), and the weight-average molecular weight of a polymer block having a minimum weight-average molecular weight is represented by Mw([II]min). In this case, the ratio “Mw([II]max)/Mw([II]min)” that is a ratio of Mw([II]max) relative to Mw([II]min) is preferably 2.0 or less, more preferably 1.5 or less, and particularly preferably 1.2 or less. By having such a ratio, fluctuations in various property values can be reduced.

The form of the block of the block copolymer may be a chain block or radial block. Among these, a chain block is preferable because of excellent mechanical strength.

When the block copolymer has the form of the chain block, it is preferable that the block copolymer has the polymer blocks [I] at both ends thereof since stickiness of the second resin (B) can be reduced.

A particularly preferable form of the block of the block copolymer may include a triblock copolymer in which polymer blocks [I] are bonded to both ends of the polymer block [II]; and a pentablock copolymer in which polymer blocks [II] are bonded to both ends of the polymer block [I] and the polymer block [I] is further bonded to each of the other end of the both polymer blocks [II]. In particular, a triblock copolymer of [I]-[II]-[I] is especially preferable since the production is easy and properties such as a viscosity can be controlled to fall within desired ranges.

In the specific block copolymer (B2a), a ratio (w_{I}/w_{II}) of a weight fraction w_{I} of the entire polymer block [I] in the entire block copolymer and a weight fraction w_{II} of the entire polymer block [II] in the entire block copolymer is preferably 50/50 or more, and more preferably 70/30 or more, and is preferably 95/5 or less, and more preferably 90/10 or less. When the ratio w_{I}/w_{II} is equal to or more than the lower limit value of the aforementioned range, heat resistance of the second resin (B) can be improved. When the ratio is equal to or less than the upper limit value, flexibility of the second resin (B) can be enhanced, and the layered film 10 having good properties can be obtained.

The weight-average molecular weight (Mw) of the specific block copolymer (B2a) is preferably 30,000 or more, more preferably 40,000 or more, and further more preferably 50,000 or more, and is preferably 200,000 or less, more preferably 150,000 or less, and further more preferably 100,000 or less. The weight-average molecular weight of the block copolymer (B2a) may be measured using gel permeation chromatography (GPC). Examples of the solvent used in GPC may include tetrahydrofuran. In the case of using GPC, the weight-average molecular weight is measured as a polystyrene-equivalent relative molecular weight, for example.

The molecular weight distribution (Mw/Mn) of the block copolymer (B2a) is preferably 3 or less, more preferably 2 or less, and particularly preferably 1.5 or less, and is preferably 1.0 or more. Herein, Mn represents a number-average molecular weight.

The method for producing the specific block copolymer (B2a) is not particularly limited, and the specific block copolymer (B2a) may be produced by the method described in, for example, International Publication No. 2015/099079 A.

[Hydrogenated Product (B2b) of Specific Block Copolymer]

The hydrogenated product (B2b) of the block copolymer is obtained by hydrogenating the unsaturated bond of the above-mentioned specific block copolymer (B2a). Herein, the unsaturated bonds of the block copolymer (B2a) include both the aromatic and non-aromatic carbon-carbon unsaturated bonds in the main chain and the side chain of the block copolymer (B2a). The hydrogenation rate is preferably 90% or more, more preferably 97% or more, and further more preferably 99% or more, of the total unsaturated bond of the block copolymer (B2a). Higher hydrogenation rate can bring about better he heat resistance and light resistance of the second resin (B). Herein, the hydrogenation rate of the hydrogenated product (B2b) may be determined by measurement by ¹H-NMR.

In particular, the hydrogenation rate of the non-aromatic unsaturated bond is preferably 95% or more, and more preferably 99% or more. By increasing the hydrogenation rate of the non-aromatic carbon-carbon unsaturated bond, the light resistance and oxidation resistance of the second resin (B) can be further enhanced.

The hydrogenation rate of the aromatic carbon-carbon unsaturated bond is preferably 90% or more, more preferably 93% or more, and particularly preferably 95% or more. By increasing the hydrogenation rate of the carbon-carbon unsaturated bond of the aromatic ring, the glass transition temperature of the polymer block obtained by hydrogenating the polymer block [I] is increased, so that the heat resistance of the second resin (B) can be effectively increased. Furthermore, the photoelastic coefficient of the second resin (B) can be decreased to suppress the expression of retardation.

The weight-average molecular weight (Mw) of the hydrogenated product (B2b) of the block copolymer is preferably 30,000 or more, more preferably 40,000 or more, and further more preferably 45,000 or more, and is preferably 200,000, more preferably 150,000 or less, and further more preferably 100,000 or less. The weight-average molecular weight of the hydrogenated product (B2b) of the block copolymer may be measured using gel permeation chromatography (GPC). Examples of the solvent used in GPC may include tetrahydrofuran. In the case of using GPC, the weight-average molecular weight is measured as a polystyrene-equivalent relative molecular weight, for example. The molecular weight distribution (Mw/Mn) of the hydrogenated product (B2b) of the block copolymer is preferably 3 or less, more preferably 2 or less, and particularly preferably 1.8 or less, and is preferably 1.0 or more. When the weight-average molecular weight Mw and the molecular weight distribution Mw/Mn of the hydrogenated product (B2b) of the block copolymer fall within the aforementioned ranges, mechanical strength and heat resistance of the second resin (B) can be improved.

A ratio (w_{I}/w_{II}) that is a ratio of a weight fraction w_{I} of the entire polymer block [I] in the entire block copolymer and a weight fraction w_{II} of the entire polymer block [II] in the entire block copolymer in the hydrogenated product (B2b) of the block copolymer is usually the same value as the ratio w_{I}/w_{II} in the block copolymer before hydrogenation.

The hydrogenated product (B2b) of the block copolymer may have an alkoxysilyl group in its molecular structure. The hydrogenated product of the block copolymer having an alkoxysilyl group may be obtained, for example, by bonding an alkoxysilyl group to the hydrogenated product of a block copolymer having no alkoxysilyl group. In this case, an alkoxysilyl group may be directly bonded to the hydrogenated product of the block copolymer (B2a), or may be bonded via a divalent organic group such as an alkylene group.

The method for producing the hydrogenated product (B2b) of the block copolymer usually includes hydrogenating the above-mentioned specific block copolymer (B2a). The specific method of hydrogenation and specific method of introducing an alkoxysilyl group performed as necessary are not particularly limited, and may be performed by the methods described in, for example, International Publication No. 2015/099079. The hydrogenated product (B2b) of the obtained block copolymer may be formed into any shape such as a pellet shape to be used for subsequent operations.

When the polymer constituting the second resin (B) is the polymer (B2) having an aromatic vinyl compound hydrogenated product unit (a) and a chain conjugated diene compound hydrogenated product unit (b) such as the above-described hydrogenated product (B2b) of the block copolymer, the weight ratio (a)/(b) that is a ratio of the aromatic vinyl compound hydrogenated product unit (a) relative to the chain conjugated diene compound hydrogenated product unit (b) in the polymer (B2) preferably fall within a specific range. The ratio (a)/(b) is preferably 50/50 or more, and more preferably 70/30 or more, and is preferably 95/5 or less, and more preferably 90/10 or less. When the ratio (a)/(b) falls within such a range, it is possible to easily obtain the layered film 10 excellent in the above-described various properties.

The amount of “the polymer (B1) belonging to the polymer (A1) containing an alicyclic structure” or “the polymer (B2) having an aromatic vinyl compound hydrogenated product unit (a) and a chain conjugated diene compound hydrogenated product unit (b)”, in the second resin (B), is preferably 70% by weight or more, more preferably 80% by weight or more, and particularly preferably 90% by weight or more, and is preferably 99% by weight or less, more preferably 97% by weight or less, and particularly preferably 95% by weight or less. The remainder may be composed of other polymers or optional additives. When the amount of the polymer (B1) or the polymer (B2) falls within the aforementioned range, moisture and heat resistance of the layered film 10 can be effectively improved. Therefore, when the layered film 10 is used as a protective film for a polarizer, durability of the polarizing plate under humidified conditions can be enhanced.

Examples of the optional additives that may be contained in the second resin (B) may include an ultraviolet absorber; a coloring agent such as a pigment and a dye; a plasticizer; a fluorescent brightener; a dispersant; a thermal stabilizer; a light stabilizer; an antistatic agent; an antioxidant; and a surfactant. One type thereof may be solely used, and two or more types thereof may also be used in combination at any ratio.

An ultraviolet absorber is a component having an ability to absorb ultraviolet rays. Organic compounds are usually used as such an ultraviolet absorber. The use of ultraviolet absorber as an organic compound can enhance light transmittance of the layered film 10 in the visible wavelength region and decrease haze of the layered film 10 as compared with the case where an ultraviolet absorber made of an inorganic compound is used. Therefore, the display performance of an image display device including the layered film 10 can be improved.

Examples of the ultraviolet absorber as an organic compound may include a triazine-based ultraviolet absorber, a benzophenone-based ultraviolet absorber, a benzotriazole-based ultraviolet absorber, an acrylonitrile-based ultraviolet absorber, a salicylate-based ultraviolet absorber, a cyanoacrylate-based ultraviolet absorber, an azomethine-based ultraviolet absorber, an indole-based ultraviolet absorber, a naphthalimide-based ultraviolet absorber, and a phthalocyanine-based ultraviolet absorber.

As the triazine-based ultraviolet absorber, for example, a compound having a 1,3,5-triazine ring is preferable. Specific examples of the triazine-based ultraviolet absorber may include 2-(4,6-diphenyl-1,3,5-triazin-2-yl)-5-[(hexyl)oxy]-phenol, and 2,4-bis(2-hydroxy-4-butoxyphenyl)-6-(2,4-dibutoxyphenyl)-1,3,5-triazine. Examples of commercially available products of such a triazine-based ultraviolet absorber may include “TINUVIN 1577” manufactured by Ciba Specialty Chemicals Co., Ltd., and “LA-F70” and “LA-46” manufactured by ADEKA Corporation.

Examples of the benzotriazole-based ultraviolet absorber may include 2,2′-methylenebis[4-(1,1,3,3-tetramethylbutyl)-6-(2H-benzotriazol-2-yl)phenol], 2-(3,5-di-tert-butyl-2-hydroxyphenyl)-5-chlorobenzotriazole, 2-(2H-benzotriazol-2-yl)-p-cresol, 2-(2H-benzotriazol-2-yl)-4,6-bis(1-methyl-1-phenylethyl)phenol, 2-benzotriazol-2-yl-4,6-di-tert-butylphenol, 2-[5-chloro(2H)-benzotriazol-2-yl]-4-methyl-6-(tert-butyl)phenol, 2-(2H-benzotriazol-2-yl)-4,6-di-tert-butylphenol, 2-(2H-benzotriazol-2-yl)-4-(1,1,3,3-tetramethylbutyl)phenol, 2-(2H-benzotriazol-2-yl)-4-methyl-6-(3,4,5,6-tetrahydrophthalimidylmethyl)phenol, a reaction product of methyl 3-(3-(2H-benzotriazol-2-yl)-5-tert-butyl-4-hydroxyphenyl)propionate/polyethylene glycol 300, and 2-(2H-benzotriazol-2-yl)-6-(linear and side chain dodecyl)-4-methylphenol. Examples of commercially available products of such a triazole-based ultraviolet absorber may include “Adekastab LA-31” manufactured by ADEKA Corporation, and “TINUVIN 326” manufactured by Ciba Specialty Chemicals Co., Ltd.

Examples of the azomethine-based ultraviolet absorber may include the materials described in Japanese Patent No. 3366697 B, and examples of commercially available products thereof may include “BONASORB UA-3701” manufactured by Orient Chemical Industries Co., Ltd.

Examples of the indole-based ultraviolet absorber may include the materials described in Japanese Patent No. 2846091 B, and examples of commercially available products thereof may include “BONASORB UA-3911” and “BONASORB UA-3912” manufactured by Orient Chemical Industries Co., Ltd.

Examples of the phthalocyanine-based ultraviolet absorber may include the materials described in Japanese Patent No. 4403257 B and Japanese Patent No. 3286905 B, and examples of commercially available products thereof may include “FDB001” and “FDB002” manufactured by Yamada Chemical Co., Ltd.

Examples of the particularly preferable ultraviolet absorber may include “LA-F70” manufactured by ASDEKA Corporation which is a triazine-based ultraviolet absorber, “UA-3701” manufactured by Oriental Chemical Industries Co., Ltd. which is an azomethine-based ultraviolet absorber, and “Tinuvin 326” manufactured by BASF Co., Ltd. Which is a benzotriazole-based ultraviolet absorber. Since these materials are particularly excellent in ultraviolet absorbing ability near a wavelength of 380 nm, the light transmittance of the layered film 10 at the wavelength of 380 nm can be particularly lowered even with a small amount.

The amount of the additive in the second resin (B) is preferably 3% by weight or more, more preferably 5% by weight or more, and particularly preferably 7% by weight or more, and is preferably 15% by weight or less, more preferably 13% by weight or less, and particularly preferably 11% by weight or less. When the amount of the additive is equal to or more than the lower limit value of the aforementioned range, the function of the additive can be effectively exerted in the layered film 10. When the amount is equal to or more than the lower limit value, increase in the thickness of the second layer 12 can be avoided, so that the sufficient thickness of the first layer 11 and the third layer 13 can be ensured. Since the first layer 11 and the third layer 13 have a sufficient thickness, the layered film 10 can have excellent heat resistance and other properties. When the amount of the additive is equal to or less than the upper limit value of the aforementioned range, gelling of the second resin (B) can be suppressed. When the amount is equal to or less than the upper limit value, the additive can be stably kneaded.

A description will be subsequently given of properties and the like that may be required of the second resin (B).

The indentation elastic modulus of the second resin (B) may be lower than the indentation elastic modulus of the first resin (A). This is because the second layer 12 is disposed between the first layer 11 and the third layer 13 as described above. The indentation elastic modulus of the second resin (B) containing the additive is usually lower than the indentation elastic modulus of the first resin (A). The indentation elastic modulus of the second resin (B) in terms of the measured value using a film of the second resin (B) having a thickness of 100 μm is preferably 1000 MPa or more, more preferably 1250 MPa or more, and particularly preferably 1500 MPa or more. When the indentation elastic modulus is equal to or more than the lower limit value, the low rigidity of the second layer 12 can be compensated with the excellent rigidity of the first layer 11 and the third layer 13. The upper limit value of the indentation elastic modulus of the second resin (B) is usually set to be the same as that of the first resin (A).

The water vapor transmission rate of the second resin (B) may be higher than the water vapor transmission rate of the first resin (A). This is because the second layer 12 is disposed between the first layer 11 and the third layer 13 as described above. The water vapor transmission rate of the second resin (B) in terms of the measured value when measured in accordance with JIS K 7129 B (1992) using a film of the second resin (B) having a thickness of 100 μm, is preferably 20 g/m²·day or less, more preferably 10 g/m²·day or less, and particularly preferably 3 g/m²·day or less, and its lower limit value is ideally zero and may be 0.1 g/m²·day. When the water vapor transmission rate is equal to or less than the upper limit value, the second layer 12 can have sufficient low moisture permeability to ensure the low moisture permeability required of the layered film 10.

The impact strength of the second resin (B) may be lower than the impact strength of the first resin (A). This is because the second layer 12 is disposed between the first layer 11 and the third layer 13 as described above. The impact strength of the second resin (B) in terms of the measured value using a film of the second resin (B) having a thickness of 100 μm is preferably 0.5×10⁻² J or more, more preferably 0.7×10⁻² J or more, and particularly preferably 1.0×10⁻² J or more. When the impact strength is equal to or more than the lower limit value, the second layer 12 can have sufficient rigidity for the rigidity required of the layered film 10. The upper limit value of the impact strength of the second resin (B) is usually set to be the same as that of the first resin (A).

The glass transition temperature of the second resin (B) is preferably 100° C. or higher, more preferably 110° C. or higher, and particularly preferably 120° C. or higher, and is preferably 160° C. or lower. When the glass transition temperature of the second resin (B) is equal to or higher than the lower limit value of the aforementioned range, sufficient durability to be required of the layered film 10 in a high temperature environment can be ensured. As described above, the upper limit value of the glass transition temperature of the second resin (B) is set to a range which is lower than the glass transition temperature of the first resin (A) and is also lower than the glass transition temperature of the third resin (C).

Herein, the value ΔTg showing the difference between the glass transition temperature of the second resin (B) and the glass transition temperature of the first resin (A) is preferably 50° C. or lower, more preferably 40° C. or lower, and particularly preferably 30° C. or lower. When the difference ΔTg in the glass transition temperature falls within the aforementioned range, the low heat resistance of the second layer 12 can be compensated with the first layer 11, and in turn, the entire layered film 10.

The range of possible values of the refractive index of the second resin (B) is usually set to be the same as that of the first resin (A) in accordance with the refractive index required of the layered film 10. The range of possible values of the saturated water absorption rate of the second resin (B) is usually set to be the same as that of the first resin (A) in accordance with the saturated water absorption rate required of the layered film 10.

The absolute value of the photoelastic coefficient of the second resin (B) may be an optional value selected from the range described in the description of the absolute value of the photoelastic coefficient of the first resin (A). This provides the same advantages as described in the description of the photoelastic coefficient of the first resin (A). In particular, the photoelastic coefficient of the second resin (B) is preferably the same as the photoelastic coefficient of the first resin (A).

The light transmittance of the second resin (B) at a wavelength of 380 nm in terms of the measurement value using a film of the second resin (B) having a thickness of 100 μm is preferably 8% or less, more preferably 5% or less, and particularly preferably 3% or less. Such light transmittance can be realized by using an ultraviolet absorber as an additive contained in the second resin (B). When the light transmittance is equal to or less than the upper limit value, deterioration of the first layer 11 due to ultraviolet rays, and in turn, deterioration of the layered film 10 due to ultraviolet rays can be suppressed. When the layered film 10 is used as a protective film for a polarizer, degradation of the polarizer due to ultraviolet rays can be suppressed. The light transmittance may be measured using a commercially available spectrophotometer in accordance with JIS K 0115 (General rules for molecular absorptiometric analysis).

The tensile elastic modulus of the second resin (B) in terms of the measurement value using a film of the second resin (B) having a thickness of 100 μm is preferably 1000 MPa or more, more preferably 1250 MPa or more, and particularly preferably 1500 MPa or more, and is preferably 4500 MPa or less, more preferably 3500 MPa or less, and particularly preferably 3000 MPa or less. When the tensile elastic modulus is equal to or more than the lower limit value, rigidity of the second layer 12, and in turn, tensile elasticity of the layered film 10 can be sufficiently elevated to an excellent level. When the tensile elastic modulus is equal to or less than the upper limit value, flexibility of the second layer 12 can be ensured.

The method for producing the second resin (B) may be selected from methods capable of dispersing the additive in the second resin (B). For example, the second resin (B) may be produced by mixing a polymer and an additive. The second resin (B) is usually produced by kneading the polymer and the additive at a temperature at which the polymer can melt. For kneading, for example, a twin-screw extruder may be used.

[4. Third Layer]

As previously described, the third layer 13 is formed of the third resin (C). The indentation elastic modulus of the third resin (C) measured using a film of the third resin (C) having a thickness of 100 μm is 2200 MPa or more. Accordingly, the layered film 10 can have excellent rigidity. The water vapor transmission rate of the third resin (C) measured in accordance with JIS K7129 B (1992) using a film of the third resin (C) having a thickness of 100 μm is 5 g/m²·day or less. Accordingly, the layered film 10 can have excellent low moisture permeability. When a resin satisfying these properties is adopted as the third resin (C), the layered film 10 can have excellent heat resistance even when it contains the second resin (B) having a relatively low glass transition temperature.

The thickness of the third layer 13 (T₁₃ shown in FIG. 1) is preferably 5 μm or more, more preferably 8 μm or more, and particularly preferably 10 μm or more, and is preferably 20 μm or less, more preferably 18 μm or less, and particularly preferably 15 μm or less. When the thickness of the third layer 13 is equal to or more than the lower limit value of the aforementioned range, bleed-out of an additive that may be contained in the second layer 12 can be effectively suppressed. When the thickness of the third layer 13 is equal to or less than the upper limit value of the aforementioned range, the second layer 12 becomes thicker. Accordingly, the amount of an additive in the material constituting the second layer 12 can be increased so that the function exerted by the additive in the layered film 10 can be enhanced. The thickness of the third layer 13 is preferably substantially the same as the thickness of the first layer 11. Accordingly, the curling of the layered film 10 can be suppressed.

It is preferable that the third resin (C) does not contain an additive, from the viewpoint of the suppression of bleed-out. That is, it is preferable that the third resin (C) is formed of a resin not containing an additive. The third resin (C) is usually a thermoplastic resin. Therefore, the third resin (C) usually contains a thermoplastic polymer.

As the thermoplastic polymer, a polymer satisfying the aforementioned properties is used. As the polymer constituting the third resin (C), one type thereof may be solely used, and two or more types thereof may also be used in combination at any ratio. The polymer may be a homopolymer or a copolymer.

As the polymer constituting the third resin (C), an optional polymer selected from the range of polymers capable of constituting the first resin (A) may be used. The contained components and properties of the third resin (C) to be adopted may be selected from the range having been described as the contained components and properties of the first resin (A). Accordingly, the third layer 13 and the third resin (C) can have the same advantages as those having been described for the first layer 11 and the first resin (A). However, the third resin (C) may be a resin different from the first resin (A), or may be the same resin as the first resin (A).

A polymer (C1) belonging to the polymer (A1) containing an alicyclic structure that has been described as the polymer capable of constituting the first resin (A) is preferably used as the polymer to be contained in the third resin (C). However, since the polymer (C1) and the polymer (A1) containing an alicyclic structure are each a polymer, they are usually not a completely identical compound. Therefore, they may be different in polymerization degrees, hydrogenation rates, ratios of structural units having an alicyclic structure, and the like. Accordingly, the same advantage as that having been described for the polymer of the first resin (A) can be obtained.

[4. Optional Layer]

The layered film 10 may include, as necessary, an optional layer in combination with the aforementioned first layer 11, second layer 12, and third layer 13. For example, an optional resin layer may be disposed at positions such as between the first layer 11 and the second layer 12, between the second layer 12 and the third layer 13, opposite to the second layer 12 of the first layer 11, or opposite to the second layer 12 of the third layer 13. Examples of the optional resin layer may include a hardcoat layer, a low refractive index layer, an antistatic layer, and an index matching layer.

However, from the viewpoint of reducing thickness of the layered film 10, the layered film 10 is preferably a film having a three-layer structure without including an optional layer.

[5. Setting of Thickness in Layered Film]

In the layered film 10, the thickness ratio is set so as to fall within the range of 1 or more and 4 or less. Herein, the thickness ratio refers to the value “(T₁₁+T₁₃)/T₁₂” of the ratio of the sum of the thickness of the first layer 11 and the thickness of the third layer 13 (T₁₁+T₁₃) relative to the thickness of the second layer 12 (T₁₂). The thickness ratio is 1 or more, more preferably 1.5 or more, and particularly preferably 2.0 or more. When the thickness ratio is equal to or more than the lower limit value, the thickness of the first layer 11 and the thickness of the third layer 13 can be sufficiently ensured. Accordingly, the layered film 10 can have excellent heat resistance and rigidity. Also, the thickness ratio is preferably 4 or less, and more preferably 3 or less. When the thickness ratio is equal to or less than the upper limit value, a large thickness can be given to the second layer 12 so that the function of an additive that may be contained in the second layer can be sufficiently exerted. Furthermore, when the thickness ratio falls within the aforementioned range in cases wherein the second resin (B) constituting the second layer 12 contains an additive, the function possessed by the additive can be sufficiently exerted in the layered film 10 while suppressing the bleed-out of the additive.

The total thickness of the layered film 10 is usually 20 μm or more, preferably 25 μm or more, and more preferably 30 μm or more, and is preferably 50 μm or less, more preferably 47 μm or less, and particularly preferably 45 μm or less. Herein, the total thickness of the layered film 10 refers to the sum of the thickness of the first layer 11, the thickness of the second layer 12, the thickness of the third layer 13, and the thickness of an optional layer. When an optional layer is absent, the thickness of an optional layer is treated as zero. When the total thickness is equal to or more than the lower limit value, heat resistance and rigidity required for the application as an optical film and the like can be ensured. When the total thickness is equal to or less than the upper limit value, light weight properties and space saving properties required for the application as an optical film and the like can be ensured.

[6. Properties of Layered Film]

The indentation elastic modulus of the layered film 10 is preferably 2200 MPa or more, more preferably 2300 MPa or more, and still more preferably 2400 MPa or more, and preferably 4000 MPa or less, and particularly preferably 3000 MPa or less. Accordingly, excellent rigidity and flexibility can be exerted.

The water vapor transmission rate of the layered film 10 is preferably 11 g/m²·day or less, more preferably 9 g/m²·day or less, and particularly preferably 7 g/m²·day or less. The lower limit value thereof is ideally zero, and may be 0.1 g/m²·day. Accordingly, excellent low water permeability can be exerted. The layered film 10 having such excellent low water permeability can be achieved by imposing the limitation of selecting the aforementioned type of polymer being excellent in low hygroscopicity or in low moisture permeability from a plurality of types of polymers capable of constituting the resins constituting the respective layers of the layered film 10.

The impact strength of the layered film 10 is preferably 1×10⁻² J or more, and more preferably 3×10⁻² J or more, and is preferably 5×10⁻² J or less. Accordingly, excellent flexibility can be exerted.

The light transmittance of the layered film 10 at a wavelength of 380 nm is preferably 3% or less, more preferably 2% or less, and particularly preferably 1% or less. The lower limit value thereof is ideally zero, and may be 0.0001%. Accordingly, deterioration due to ultraviolet rays, and particularly deterioration due to long-wavelength ultraviolet rays can be suppressed. The light transmittance of the layered film 10 at a wavelength of 380 nm can be lowered by, for example, appropriately selecting the type of an ultraviolet absorber to be used as an additive in the second layer 12, or adjusting the concentration of the used ultraviolet absorber and the thickness of the second layer 12. In general, an organic component contained in an organic EL element is likely to be deteriorated particularly due to long-wavelength ultraviolet rays. Therefore, when the layered film 10 is used for an organic EL element, excellent effects come to be exerted particularly in terms of the suppression of deterioration.

The layered film 10 preferably has a high total light transmittance in applications such as optical films. The specific total light transmittance of the layered film 10 is preferably 85% to 100%, more preferably 87% to 100%, and particularly preferably 90% to 100%. The total light transmittance may be measured using a commercially available spectrophotometer in a wavelength range of 400 nm or more and 700 nm or less.

From the viewpoint of enhancing the image sharpness of the image display device in which the layered film 10 is incorporated, the layered film 10 preferably has a small haze. The haze of the layered film 10 is preferably 1% or less, more preferably 0.8% or less, and particularly preferably 0.5% or less. The haze may be measured using a turbidity meter in accordance with JIS K 7361-1997.

The layered film 10 may be an optically isotropic film having substantially no in-plane retardation Re. The layered film 10 may also be an optically anisotropic film having an in-plane retardation Re at a degree suitable for the use application. For example, when the layered film 10 is an optically isotropic film, the specific in-plane retardation of the layered film 10 is preferably 0 nm to 15 nm, more preferably 0 nm to 10 nm, and particularly preferably 0 nm to 5 nm. Further, for example, when the layered film 10 is an optically anisotropic film capable of functioning as a ¼ wave plate, the specific in-plane retardation of the layered film 10 is preferably 85 nm or more, more preferably 90 nm or more, and particularly preferably 95 nm or more, and is preferably 150 nm or less, more preferably 140 nm or less, and particularly preferably 120 nm or less.

The amount of the volatile component contained in the layered film 10 is preferably 0.1% by weight or less, more preferably 0.05% by weight or less, and further preferably 0.02% by weight or less. When the amount of the volatile component falls within the aforementioned range, size stability of the layered film 10 can be improved and time-dependent change in the optical properties such as retardation can be reduced. Furthermore, deterioration of the polarizing plate including the layered film 10 and the image display device can be suppressed, and the display quality of the image display device can be kept stable and favorable over a long period of time. Herein, the volatile component is a substance having a molecular weight of 200 or less. Examples of the volatile components may include residual monomers and solvents. The amount of volatile components may be quantified as the sum of substances with a molecular weight of 200 or less by analyzing with gas chromatography.

The saturated water absorption rate of the layered film 10 is preferably 0.05% or less, more preferably 0.03% or less, particularly preferably 0.01% or less, and ideally zero %. Such a low saturated water absorption rate of the layered film 10 makes it possible to suppress changes in sizes and optical properties of the layered film 10 with the lapse of time.

[7. Method for Producing Layered Film 10]

There is no limitation to the method for producing the layered film 10. The layered film 10 may be produced, for example, by a production method including a step of molding the first resin (A), the second resin (B) and the third resin (C) into a film shape. Examples of the molding methods of the first resin (A), the second resin (B) and the third resin (C) may include a coextrusion method and a cocasting method. Among these molding methods, a coextrusion method is preferable since it is excellent in production efficiency and hardly allows volatile components to remain in the layered film 10.

The method of producing the layered film 10 using a coextrusion method includes a step of coextruding the first resin (A), the second resin (B), and the third resin (C). In the coextrusion method, the first resin (A), the second resin (B), and the third resin (C) are extruded in layers in a molten state, to form the first layer 11, the second layer 12 and the third layer 13. In this case, examples of the method for extruding respective resins may include a coextrusion T-die method, a coextrusion inflation method, and a coextrusion lamination method. Among these, a coextrusion T-die method is preferable. The coextrusion T-die method includes a feed block method and a multi-manifold method, and a multi-manifold method is particularly preferable since fluctuation in thickness can be reduced.

In the coextrusion method, the melting temperature of the first resin (A), second resin (B) and third resin (C) to be extruded is preferably Tg(p)+80° C. or higher, and more preferably Tg(p)+100° C. or higher, and is preferably Tg(p)+180° C. or lower, and more preferably Tg(p)+150° C. or lower. Herein, “Tg(p)” represents the highest temperature among the glass transition temperatures of the polymers contained in the first resin (A), the second resin (B), and the third resin (C). In the coextrusion T-die method, for example, the melting temperature represents the melting temperature of the first resin (A), the second resin (B) and the third resin (C) in the extruder having a T-die. When the melting temperature of the first resin (A), second resin (B) and third resin (C) to be extruded is equal to or more than the lower limit value of the aforementioned range, fluidity of the resin is sufficiently increased, so that good moldability can be obtained. When the melting temperature is equal to or less than the upper limit value, deterioration of the resin can be suppressed.

As the extrusion temperature, an appropriate temperature for the first resin (A), the second resin (B), and the third resin (C) may be selected. For example, the temperature of the resin in the extruder may be Tg(p) to (Tg(p)+100° C.) at the resin inlet, and (Tg(p)+50° C.) to (Tg(p)+170° C.) at the outlet of the extruder, and the die temperature may be (Tg(p)+50° C.) to (Tg(p)+170° C.)

Furthermore, the arithmetic mean roughness Ra of the die lip of the die is preferably 0 μm to 1.0 μm, more preferably 0 μm to 0.7 μm, and particularly preferably 0 μm to 0.5 μm. When the arithmetic mean roughness of the die lip falls within the aforementioned range, it becomes easy to suppress streak-shaped defects of the layered film 10.

In the coextrusion method, the film-shaped molten resin extruded from a die lip is usually brought into close contact with a cooling roll, to be cooled and cured. In this case, examples of the method of bringing the molten resin into close contact with the cooling roll may include an air knife method, a vacuum box method, and an electrostatic adhesion method.

By molding the first resin (A), the second resin (B), and the third resin (C) into a film shape as described above, the layered film 10 including the first layer 11 formed of the first resin (A), the second layer 12 formed of the second resin (B), and the third layer 13 formed of the third resin (C) in this order is obtained.

The production method of the layered film 10 may include a stretching step. By subjecting the layered film 10 obtained by molding respective resins as described above to a stretching treatment, desired optical properties such as retardation can be exerted by the layered film 10. In the following description, the “pre-stretch layered body” refers to the layered film 10 before the stretching treatment, and the “stretched layered body” refers to the layered film 10 having been subjected to the stretching treatment.

The stretching may be a uniaxial stretching treatment in which a stretching treatment is performed in only one direction, or a biaxial stretching treatment in which a stretching treatment is performed in two different directions. In the biaxial stretching treatment, a simultaneous biaxial stretching treatment in which a simultaneous stretching treatment is performed in two directions may be performed, and a sequential biaxial stretching treatment in which a stretching treatment is performed in a certain direction and then a stretching treatment is performed in another direction may be performed. Further, the stretching may be a longitudinal stretching treatment in which a stretching treatment is performed in a lengthwise direction of the pre-stretch layered body, a transverse stretching treatment in which a stretching treatment is performed in a widthwise direction of the pre-stretch layered body, and a diagonal stretching treatment in which a stretching treatment is performed in a diagonal direction neither parallel to nor perpendicular to the widthwise direction of the pre-stretch layered body. Any combination of these stretching treatments may also be performed. Among these stretching treatments, a diagonal stretching treatment is preferable.

The stretching temperature and stretching ratio may be optionally set in accordance with the optical properties of the layered film 10 to be exerted by stretching. As the specific range, the stretching temperature is preferably Tg-30° C. or higher, and more preferably Tg−10° C. or higher, and is preferably Tg+60° C. or lower, and more preferably Tg+50° C. or lower. The stretching ratio is preferably 1.01 times to 30 times, preferably 1.01 times to 10 times, and more preferably 1.01 times to 5 times.

Further, the method for producing the layered film 10 may include an optional step in addition to the above-described steps.

[8. Polarizing Plate]

The layered film 10 described above may be used for a wide range of applications as optical films such as a phase difference film, a protective film for a polarizer, a polarization compensation film and the like. Among these, the layered film 10 is preferably used as a protective film for a polarizer. A polarizing plate using the layered film 10 as a protective film for a polarizer includes a polarizer and the layered film 10.

FIG. 2 is a cross-sectional view schematically showing the polarizing plate 20 according to an embodiment of the present invention.

As shown in FIG. 2, the polarizing plate 20 includes a polarizer 21 and the layered film 10 disposed on at least one side of the polarizer 21. Such a polarizing plate 20 is excellent in durability because the layered film 10 can protect the polarizer 21 by blocking ultraviolet rays.

As the polarizer 21, a film capable of transmitting one of two linearly polarized light crossing at right angles and absorbing or reflecting the other of them may be used. Specific examples of the polarizer 21 may include a film obtained by performing appropriate treatments such as dyeing treatment with a dichroic substance such as iodine and a dichroic dye, stretching treatment, and crosslinking treatment to a film of a vinyl alcohol-based polymer such as polyvinyl alcohol and partially formalized polyvinyl alcohol in an appropriate order and method. In particular, a polarizer 21 containing polyvinyl alcohol is preferable. The thickness of the polarizer 21 is usually 5 μm to 80 μm.

When the layered film 10 can function as a ¼ wave plate, the polarized light transmission axis of the polarizer 21 and the slow axis of the layered film 10 in the polarizing plate 20 preferably form an angle of 45°±5° when the polarizing plate 20 is viewed from the thickness direction. By having such an angle, the linearly polarized light having passed through the polarizer 21 can be converted into circularly polarized light by the layered film 10.

The polarizing plate 20 may be produced by bonding the layered film 10 to the polarizer 21. At the time of bonding, an adhesive may be used if necessary.

The polarizing plate 20 may further include an optional layer (not shown) in combination with the polarizer 21 and the layered film 10 described above. For example, the polarizing plate 20 may include an optional protective film layer (not shown) other than the layered film 10 for protecting the polarizer 21. Such a protective film layer is usually disposed on the surface of the polarizer 21 opposite to the layered film 10. Further examples of the optional layer may include a hard coat layer, a low refractive index layer, an antistatic layer, and an index matching layer.

The polarizing plate 20 obtained as described above may be used for an image display device.

### EXAMPLES

Hereinafter, the present invention will be specifically described by illustrating Examples. However, the present invention is not limited to the Examples described below. The present invention may be optionally modified for implementation without departing from the scope of claims of the present invention and the scope of their equivalents.

In the following description, “%” and “part” representing quantity are on the basis of weight, unless otherwise specified. The operation described below was performed under the conditions of normal temperature and normal pressure, unless otherwise specified. “Test piece” refers to a film, according to the following Examples, Comparative Examples, and Reference Examples, cut out to a predetermined size.

[Evaluation Items]

(Thickness)

The total thickness of the layered film having a three-layer structure consisting of the first layer, the second layer, and the third layer was measured with a snap gauge.

The thickness of the second layer contained in the layered film was obtained by measuring the light transmittance of the layered film at a wavelength of 390 nm using an ultraviolet visible near-infrared spectrophotometer (“V-7200” manufactured by JASCO Corporation) and calculating the thickness from the obtained light transmittance. Furthermore, since the first layer and the third layer were formed to have the same thickness in Examples and Comparative Examples described later, the thickness of each of the first layer and the third layer was calculated by subtracting the thickness of the second layer from the total thickness of the layered film and dividing the obtained value by 2.

(Glass Transition Temperature)

The glass transition temperature was measured with a differential scanning calorimeter (a differential scanning calorimeter DSC-6100 manufactured by Seiko Instruments Inc.).

(Thickness Ratio)

From the thicknesses of respective layers obtained as previously described, the ratio of the sum of the thickness of the first layer and the thickness of the third layer relative to the thickness of the second layer was calculated.

(Heat Resistance)

A film as a test piece for a heat resistance test was left to stand under the atmosphere of 140° C. for 10 minutes without tension applied thereto. After that, the surface state of the film was visually observed.

When at least one rough portion was observed on at least one of the surfaces of the film, it was judged that the heat resistance temperature is lower than 140° C., and “failure” indicating poor heat resistance was assigned. When the rough portion was not observed on both surfaces of the film, it was judged that the heat resistance temperature is 140° C. or higher, and “good” indicating excellent heat resistance was assigned. The rough portion observed on the surface of the film after a heat resistance test herein refers to a minute rough portion which has been locally generated on the film due to the expansion or shrinkage by heat.

(Indentation Elastic Modulus)

The indentation elastic modulus (unit: MPa) of the test piece film was measured using an indentation elastic modulus tester (manufactured by Fischer Instruments K.K., trade name “Picometer Hm-500”). In the measurement, a regular quadrangular pyramid diamond indenter having an angle between the opposite faces of 136° was used as an indenter. Measurement was performed with a constant load speed at 2.5 mF/sec, and a constant dF/dt. The maximum load was 50 mN, the load time was 20 sec, and the creep time was 60 sec.

(Water Vapor Transmission Rate)

The water vapor transmission rate was measured using a water vapor permeability measuring device (“Permatran-W” manufactured by Mocon Inc.), in accordance with JIS K 7129 B, under the condition of a temperature of 40° C. and a humidity of 90% RH.

(Impact Strength)

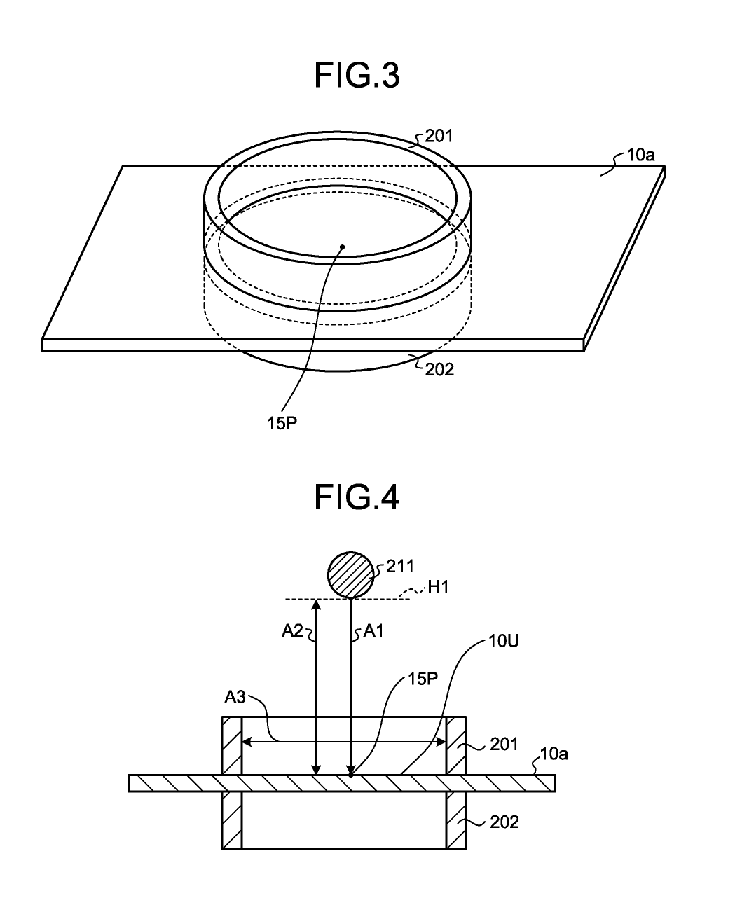

The impact strength was measured using a device schematically illustrated in FIG. 3 to FIG. 4. A film 10a as a test piece was horizontally fixed by a jig including an upper clamping ring 201 and a lower clamping ring 202 both having a hollow cylindrical shape. The inner diameter (indicated by arrow A3) of the upper clamping ring 201 and the lower clamping ring 202 was 4 cm. A steel ball 211 (a pachinko ball, weight: 5 g, diameter: 11 mm) as a striker was allowed to freely fall from a varied height h (a distance between a level H1 in the lowest portion of the steel ball 211 and an upper surface 10U of the film 10a; a height indicated by arrow A2) into the arrow A1 direction onto a position 15P on the central axis in the jig on the upper surface 10U of the film 10a fixed to the jig. The potential energy (×10⁻² J) of the steel ball 211 at the height h on the boundary between when the film 10a was not broken and when the film 10a was broken was defined to be the impact strength.

(Light Transmittance)

The light transmittance was measured in accordance with JIS K0115 (General rules for molecular absorptiometric analysis), using a spectrophotometer (manufactured by JASCO Corporation, ultraviolet visible near-infrared spectrophotometer “V-570”). The value of the light transmittance at a wavelength of 380 nm was extracted from the values of the light transmittance corresponding to the wavelengths obtained as the result of the measurement, and indicated in the table.

(Tensile Elastic Modulus)

The stress applied for straining a test piece (10 mm in width×250 mm in length) in the long edge direction to cause distortion was measured in accordance with JIS K7113, using a tensile tester equipped with a constant temperature and humidity tank (a 5564 type digital material tester manufactured by Instron Japan Company Ltd.), under the condition of a temperature of 23° C., a humidity of 60±5% RH, an inter-chuck distance of 115 mm, and a tensile rate of 100 mm/min. Such a measurement was performed three times. From measurement data of a measured stress and a distortion corresponding to the stress, measurement data were selected at intervals of 0.2% in the test piece distortion range of 0.6% to 1.2% (that is, measurement data at distortions of 0.6%, 0.8%, 1.0% and 1.2%). From the selected measurement data in three measurements, the tensile elastic modulus was calculated by a least square method.

(Production of UVA-Containing Resin)

Prior to the production of the layered films according to Examples 1 to 3 and Comparative Examples 1 to 5, a resin to constitute the second layer was produced (Production Examples 1 to 3).

### Production Example 1: Resin B+UVA

There were mixed, by a twin-screw extruder, 91 parts by weight of a dried norbornene-based polymer (“ZEONOR 1600”, glass transition temperature: 163° C., manufactured by ZEON Corporation; hereinafter, also referred to as a “resin B”) and 9 parts by weight of a benzotriazole-based ultraviolet absorber (“LA-31”, manufactured by ADEKA Corporation) as an ultraviolet absorber (UVA). Subsequently, the mixture was charged into a hopper connected to the extruder, and supplied to a single screw extruder to be melt extruded. Thus, a UVA-containing resin B (“Resin B+UVA” in the table) was obtained. The containing amount of the ultraviolet absorber in the UVA-containing resin B is 9% by weight. The glass transition temperature Tg of the UVA-containing resin B was 139° C.

### Production Example 2: Resin A+UVA

There were mixed, by a twin-screw extruder, 91 parts by weight of a dried resin A (a resin containing a hydrogenated product of a polymer X described later, glass transition temperature: 142° C.) and 9 parts by weight of a benzotriazole-based ultraviolet absorber (“LA-31”, manufactured by ADEKA Corporation) as an ultraviolet absorber (UVA). Subsequently, the mixture was charged into a hopper connected to the extruder, and supplied to a single screw extruder to be melt extruded. Thus, a UVA-containing resin A (“Resin A+UVA” in the table) was obtained. The containing amount of the ultraviolet absorber in the UVA-containing resin A is 9% by weight. The glass transition temperature Tg of the UVA-containing resin A was 121° C.

The method for producing a hydrogenated product of a polymer X will be described hereinbelow.

(First Stage in Production of Hydrogenated Product of Polymer X: Stretching First Block St by Polymerization Reaction)

Into a sufficiently dried, nitrogen substituted stainless steel reaction vessel equipped with a stirrer, 320 parts of dehydrated cyclohexane, 75 parts of styrene, and 0.38 part of dibutyl ether were charged. To the mixture, 0.41 part of an n-butyl lithium solution (a 15% by weight hexane solution) was added while stirring at 60° C. to initiate a polymerization reaction. Thus, a polymerization reaction in the first stage was performed. At the time point of 1 hour after the initiation of the reaction, a sample was taken from the reaction mixture for analysis by gas chromatography (GC). As a result, the polymerization conversion ratio was 99.5%.

(Second Stage in Production of Hydrogenated Product of Polymer X: Stretching Second Block Ip by Polymerization Reaction)

To the reaction mixture obtained in the aforementioned first stage, 15 parts of isoprene was added to subsequently initiate a polymerization reaction in the second stage. At the time point of 1 hour after the initiation of the polymerization reaction in the second stage, a sample was taken from the reaction mixture for analysis by GC. As a result, the polymerization conversion ratio was 99.5%.

(Third Stage in Production of Hydrogenated Product of Polymer X: Stretching Third Block St by Polymerization Reaction)

To the reaction mixture obtained in the aforementioned second stage, 10 parts of styrene was added to subsequently initiate a polymerization reaction in the third stage. At the time point of 1 hour after the initiation of the polymerization in the third stage, a sample was taken from the reaction mixture to measure the weight-average molecular weight Mw and number-average molecular weight Mn of the polymer X. At this point of time, the taken sample was analyzed by GC. As a result, the polymerization conversion ratio was nearly 100%. Immediately thereafter, 0.2 part of isopropyl alcohol was added to the reaction mixture to terminate the reaction. Accordingly, a mixture containing a polymer X was obtained.

It was found that the obtained polymer X is a polymer having a triblock molecular structure of first block St-second block Ip-third block St=75-15-10. The polymer X had a weight-average molecular weight (Mw) of 70,900 and a molecular weight distribution (Mw/Mn) of 1.5.

(Fourth Stage in Production of Hydrogenated Product of Polymer X: Hydrogenating Polymer X)

Subsequently, the mixture containing the polymer X was transferred into a pressure resistant reaction vessel equipped with a stirrer. Into this pressure resistant reaction vessel, 8.0 parts of a diatomaceous earth-carried nickel catalyst (product name: “E22U”, nickel carrying amount: 60%, manufactured by JGC Catalysts and Chemicals Ltd.) as a hydrogenation catalyst and 100 parts of dehydrated cyclohexane were added and mixed. The atmosphere inside the reaction vessel was substituted with hydrogen gas, and further supplied with hydrogen while stirring the solution, thereby to perform a hydrogenation reaction at a temperature of 190° C. and a pressure of 4.5 MPa for 8 hours. The hydrogenated product of the polymer X contained in the reaction solution obtained by the hydrogenation reaction had a weight-average molecular weight (Mw) of 63,300 and a molecular weight distribution (Mw/Mn) of 1.5.

(Fifth Stage in Production of Hydrogenated Product of Polymer X: Removing Volatile Matter)

After the termination of the hydrogenation reaction, the reaction solution was filtered to remove the hydrogenation catalyst. Thereafter, there was added and dissolved 2.0 parts of a xylene solution in which 0.1 part of pentaerythrityl.tetrakis[3-(3,5-di-t-butyl-4-hydroxyphenyl)propionate] (product name: “Songnox 1010” manufactured by Songwon Industrial, Co., Ltd.) as a phenol-based antioxidant was dissolved. Subsequently, the solution was treated at a temperature of 260° C. and a pressure of 0.001 MPa or less using a cylindrical concentration dryer (product name: Kontro, manufactured by Hitachi, Ltd.) to remove the solvent cyclohexane and xylene and other volatile matter from the solution. The molten polymer was extruded from a die into a strand shape, and cooled. Thereafter, pellets of the hydrogenated product of the polymer X were prepared by a pelletizer. The obtained pellet-shaped hydrogenated product of the polymer X had a weight-average molecular weight (Mw) of 62,200 and a molecular weight distribution (Mw/Mn) of 1.5. The hydrogenation rate was nearly 100%.

The hydrogenated product of the polymer X obtained in this manner was used as the resin A.

### Production Example 3: Resin C+UVA

There were mixed, by a twin-screw extruder, 91 parts by weight of a dried norbornene-based polymer (“ZEONOR 1430”, glass transition temperature: 135° C., manufactured by ZEON Corporation; hereinafter, also referred to as a “resin C”) and 9 parts by weight of a benzotriazole-based ultraviolet absorber (“LA-31”, manufactured by ADEKA Corporation) as an ultraviolet absorber (UVA). Subsequently, the mixture was charged into a hopper connected to the extruder, and supplied to a single screw extruder to be melt extruded. Thus, a UVA-containing resin C (“Resin C+UVA” in the table) was obtained. The containing amount of the ultraviolet absorber in the UVA-containing resin C is 9% by weight. The glass transition temperature Tg of the UVA-containing resin C was 114° C.

(Production of Layered Film)

Subsequently, with the UVA-containing resins according to Production Examples, the layered films according to Examples and Comparative Examples were produced in the following manner (Examples 1 to 3 and Comparative Examples 1 to 5).

### Example 1

A layered film according to Example 1 was obtained by coextrusion molding. This layered film consists of two-type three layers: the first layer formed of the resin B—the second layer formed of the UVA containing resin B according to Production Example 1—the third layer formed of the resin B.

Specifically, coextrusion molding was performed in the following manner. First, the UVA-containing resin B according to Production Example 1 was charged into a hopper loaded to a double flight type 50-mm single screw extruder (ratio between screw effective length L and screw diameter D L/D=32) provided with a leaf disc-shape polymer filter having openings of 10 μm. The molten resin was supplied to a specific manifold of a multi-manifold die having a die lip surface roughness Ra of 0.1 μm at an extruder outlet temperature of 280° C. and an extruder gear pump rotation speed of 10 rpm. Meanwhile, a norbornene-based polymer (resin B) which is the same as that used in the UVA-containing resin B according to Production Example 1 was charged into a hopper loaded to a 50-mm single screw extruder (L/D=32) provided with a leaf disc-shape polymer filter having openings of 10 μm. The molten resin was supplied to other two manifolds of the aforementioned multi-manifold die at an extruder outlet temperature of 280° C. and an extruder gear pump rotational speed of 10 rpm. Subsequently, the resin B in a molten state, the UVA-containing resin B in a molten state, and the resin B in a molten state were discharged from the corresponding multi-manifold dies at 280° C., and cast on a cooling roll having an adjusted temperature of 150° C. Thus, a layered film having a width of 600 mm was obtained. The air gap amount was set to 50 mm. As the method for casting the resin in a molten state on the cooling roll, edge pinning was adopted.

Both ends of this layered film were each trimmed by 100 mm to achieve a width of 400 mm. The total thickness of this layered film was 40 μm, and the thickness of the second layer was 20 μm. Therefore, the thickness of the first layer and the thickness of the third layer were each determined to be 10 μm. Thus, the thickness ratio was 1.0. The thickness ratio herein indicates the ratio of the sum of the thickness of the first layer and the thickness of the third layer relative to the thickness of the second layer. The judgment result for heat resistance was “good”. These results and other evaluation results of the layered film according to Example 1 are shown in Table 1. In Table 1, the evaluation results of Examples 2 and 3 are also shown.

In Table 1, abbreviations mean as follows. The same applies to abbreviations in Table 2 described later.

Tg: the glass transition temperature of the resin

Total thickness: the sum of the thickness of the first layer, the thickness of the second layer, and the thickness of the third layer

Thickness ratio: the ratio of the sum of the thickness of the first layer and the thickness of the third layer relative to the thickness of the second layer

Heat resistance: the judgment result for heat resistance

Light transmittance: the light transmittance at a wavelength of 380 nm

### Example 2

A layered film according to Example 2 was produced in the same manner as that of Example 1, except that the material of the second layer in the layered film of Example 1 was changed to the UVA-containing resin A according to Production Example 2 instead of the UVA-containing resin B according to Production Example 1. The total thickness of this layered film was 40 μm, and the thickness of the second layer was 20 μm. Therefore, the thickness of the first layer and the thickness of the third layer were each determined to be 10 μm. Thus, the thickness ratio was 1.0. The judgment result for heat resistance was “good”.

### Example 3

A layered film according to Example 3 was produced in the same manner as that of Example 2, except that the thickness ratio of the layered film of Example 2 was changed. The total thickness of this layered film was 40 μm, and the thickness of the second layer was 10 μm. Therefore, the thickness of the first layer and the thickness of the third layer were each determined to be 15 μm. Thus, the thickness ratio was 3.0. The judgment result for heat resistance was “good”.

### Comparative Example 1

A layered film according to Comparative Example 1 was produced in the same manner as that of Example 1, except that the thickness ratio of the layered film of Example 1 was changed. The total thickness of this layered film was 40 μm, and the thickness of the second layer was 30 μm. Therefore, the thickness of the first layer and the thickness of the third layer were each determined to be 5 μm. Thus, the thickness ratio was 0.3. The judgment result for heat resistance was “failure”. These results and other evaluation results of the layered film according to Comparative Example 1 are shown in Table 2. Table 2 also shows the evaluation results of Comparative Examples 2 to 5.

### Comparative Example 2

A layered film according to Comparative Example 2 was produced in the same manner as that of Comparative Example 1, except that the material of the second layer in the layered film of Comparative Example 1 was changed to the UVA-containing resin A according to Production Example 1 instead of the UVA-containing resin B according to Production Example 1. The total thickness of this layered film was 40 μm, and the thickness of the second layer was 30 μm. Therefore, the thickness of the first layer and the thickness of the third layer were each determined to be 5 μm. Thus, the thickness ratio was 0.3. The judgment result for heat resistance was “failure”.

### Comparative Example 3

A layered film according to Comparative Example 3 was produced in the same manner as that of Example 1, except that the material of the first layer in the layered film of Example 1 was changed to the resin A instead of the resin B and the material of the third layer was changed to the resin A instead of the resin B. The total thickness of this layered film was 40 μm, and the thickness of the second layer was 20 μm. Therefore, the thickness of the first layer and the thickness of the third layer were each determined to be 10 μm. Thus, the thickness ratio was 1.0 which is the same as that in Example 1. The judgment result for heat resistance was “failure”.

### Comparative Example 4

A layered film according to Comparative Example 4 was produced in the same manner as that of Example 1, except that the material of the first layer in the layered film of Example 1 was changed to the resin C instead of the resin B, the material of the third layer was changed to the resin C instead of the resin B, and the material of the second layer was changed to the UVA-containing resin C according to Production Example 3 instead of the UVA-containing resin B according to Production Example 1. The total thickness of this layered film was 40 μm, and the thickness of the second layer was 20 μm. Therefore, the thickness of the first layer and the thickness of the third layer were each determined to be 10 μm. Thus, the thickness ratio was 1.0 which is the same as that in Example 1. The judgment result for heat resistance was “failure”.

### Comparative Example 5

A layered film according to Comparative Example 5 was produced in the same manner as that of Example 2, except that the material of the first layer in the layered film of Example 2 was changed to the resin A instead of the resin B and the material of the third layer was changed to the resin A instead of the resin B. The total thickness of this layered film was 40 μm, and the thickness of the second layer was 20 μm. Therefore, the thickness of the first layer and the thickness of the third layer were each determined to be 10 μm. Thus, the thickness ratio was 1.0 which is the same as that in Example 2. The judgment result for heat resistance was “failure”.

TABLE 1

| | | Ex. 1 | Ex. 2 | Ex. 3 |
|---|---|---|---|---|
| Resin | Third layer | Resin B | Resin B | Resin B |
| | Second layer | Resin | Resin | Resin |
| | | B + UVA | A + UVA | A + UVA |
| | First layer | Resin B | Resin B | Resin B |
| Thickness | Third layer | 10 | 10 | 15 |
| (μm) | Second layer | 20 | 20 | 10 |
| | First layer | 10 | 10 | 15 |
| Total thickness (μm) | | 40 | 40 | 40 |
| Tg (° C.) | Third layer | 163 | 163 | 163 |
| | Second layer | 139 | 121 | 121 |
| | First layer | 163 | 163 | 163 |

| | | | |
|---|---|---|---|
| Thickness ratio | 1.0 | 1.0 | 3.0 |
| Heat resistance | Good | Good | Good |
| Indentation elastic | 2600 | 2400 | 2500 |
| modulus (MPa) | | | |
| Water vapor transmission | 3.1 | 6 | 4.6 |
| rate (g/m² · day) | | | |
| Impact strength (×10⁻² J) | More than | 3.4 | 5.2 |
| | 9.6 | | |
| Light transmittance (%) | 0.007 | 0.007 | 0.8 |
| Tensile elastic modulus | 2500 | 2150 | 2300 |
| (MPa) | | | |

TABLE 2

| | | Comp. Ex. 1 | Comp. Ex. 2 | Comp. Ex. 3 | Comp. Ex. 4 | Comp. Ex. 5 |
|---|---|---|---|---|---|---|
| Resin | Third | Resin B | Resin B | Resin A | Resin C | Resin A |
| | layer | | | | | |
| | Second | Resin B + | Resin A + | Resin B + | Resin C + | Resin A + |
| | layer | UVA | UVA | UVA | UVA | UVA |
| | First | Resin B | Resin B | Resin A | Resin C | Resin A |
| | layer | | | | | |
| Thickness | Third | 5 | 5 | 10 | 10 | 10 |
| (μm) | layer | | | | | |
| | Second | 30 | 30 | 20 | 20 | 20 |
| | layer | | | | | |
| | First | 5 | 5 | 10 | 10 | 10 |
| | layer | | | | | |
| Total thickness | | 40 | 40 | 40 | 40 | 40 |
| (μm) | | | | | | |
| Tg (° C.) | Third | 163 | 163 | 142 | 135 | 142 |
| | layer | | | | | |
| | Second | 139 | 121 | 139 | 114 | 121 |
| | layer | | | | | |
| | First | 163 | 163 | 142 | 135 | 142 |
| | layer | | | | | |

| | | | | | |
|---|---|---|---|---|---|
| Thickness ratio | 0.3 | 0.3 | 1.0 | 1.0 | 1.0 |
| Heat resistance | Failure | Failure | Failure | Failure | Failure |
| Indentation elastic | 2500 | 2100 | 1600 | 2000 | 1600 |
| modulus (MPa) | | | | | |
| Water vapor | 3.2 | 7.5 | 6.1 | 3.1 | 9.2 |
| transmission rate | | | | | |
| (g/m² · day) | | | | | |
| Impact strength | More than | 1.8 | 1.3 | More than | 1.1 |
| (×10⁻²J) | 9.6 | | | 9.6 | |
| Light transmittance | 0.000 | 0.000 | 0.007 | 0.007 | 0.007 |
| (%) | | | | | |
| Tensile elastic | 2500 | 1975 | 2100 | 2100 | 1700 |
| modulus (MPa) | | | | | |

(Discussion)

It became apparent that, when the material of the first layer, the material of the second layer, and the material of the third layer contains the same polymer, the glass transition temperature of the material of the second layer containing an ultraviolet absorber is lower than the glass transition temperature of the material of the first layer, and is also lower than the glass transition temperature of the material of the third layer.

In comparison between Example 1 and Comparative Example 1, a tendency was found in which the larger thickness ratio leads to the better judgment result for heat resistance, and the smaller thickness ratio leads to the poorer judgment result for heat resistance. The same was also found in comparison between Example 2 and Comparative Example 2.

In comparison among Examples 1 and 2 and Comparative Examples 3 to 5, it was found that the judgment result for heat resistance also depends on the type of the material of a resin constituting the layered film.

<Reference Examples 1 to 4>

With respect to the fact that the judgment result for heat resistance depends on the type of the material of a resin, a film of the resin A, a film of the resin B, and a film of the resin C, each having a thickness of 100 μm, were prepared, and compared to each other on the judgment result for heat resistance, indentation elastic modulus, water vapor transmission rate, impact strength, and tensile elastic modulus. The comparison results are shown in Table 3. In Table 3, the evaluation result of a PET (polyethylene terephthalate) film with a thickness of 100 μm is also shown for reference.

In Table 3, abbreviations mean as follows.

Tg: the glass transition temperature of the resin

Heat resistance: the judgment result for heat resistance

Light transmittance: the light transmittance at a wavelength of 380 nm

TABLE 3

| | Ref. Ex. 1 | Ref. Ex. 2 | Ref. Ex. 3 | Ref. Ex. 4 |
|---|---|---|---|---|
| Resin | PET | Resin B | Resin C | Resin A |
| Thickness (μm) | 100 | 100 | 100 | 100 |
| Tg (° C.) | — | 163 | 135 | 142 |
| Heat resistance | — | Good | Failure | Failure |
| Indentation | — | 2600 | 2000 | 1600 |
| elastic modulus | | | | |
| (MPa) | | | | |
| Water vapor | 5.3 | 0.8 | 0.9 | 3 |
| transmission | | | | |
| rate (g/m² · day) | | | | |
| Impact strength | — | More than | More than | 1.1 |
| (×10⁻² J) | | 9.6 | 9.6 | |
| Tensile elastic | — | 2500 | 2100 | 1800 |
| modulus (MPa) | | | | |

As understood from Table 3, the resin A, the resin B, and the resin C (corresponding to Reference Examples 2 to 4, respectively) all have water vapor transmission rate better than PET for reference (Reference Example 1). Also, it became clear that the resin B is excellent in the judgment result for heat resistance, indentation elastic modulus, impact strength, and tensile elastic modulus, among the resin A, the resin B, and the resin C. Therefore, in further consideration of the results of Examples 1 to 3, it was found that the resin B is particularly preferably used as the material of the first layer and the third layer which protect the second layer. On the other hand, it became clear that although the resin A has a judgment result for heat resistance poorer than the resin B among the resin A, the resin B, and the resin C, it can be used as the material of the second layer when the results of Examples 2 and 3 are additionally considered.

### REFERENCE SIGN LIST

10 layered film
10a film
10U upper surface of film
11 first layer
12 second layer
13 third layer
15P position on the central axis
20 polarizing plate
21 polarizer
201 upper clamping ring
202 lower clamping ring
211 steel ball

1. A layered film comprising a first layer formed of a first resin, a second layer formed of a second resin, and a third layer formed of a third resin, which are provided in this order, wherein
the second resin has a glass transition temperature that is lower than a glass transition temperature of the first resin and lower than a glass transition temperature of the third resin,
the first resin has an indentation elastic modulus of 2200 MPa or more, the indentation elastic modulus being measured using a film of the first resin having a thickness of 100 μm,
the third resin has an indentation elastic modulus of 2200 MPa or more, the indentation elastic modulus being measured using a film of the third resin having a thickness of 100 μm,
the first resin has a water vapor transmission rate of 5 g/m²·day or less, the water vapor transmission rate being measured in accordance with JIS K7129 B (1992) using a film of the first resin having a thickness of 100 μm,
the third resin has a water vapor transmission rate of 5 g/m²·day or less, the water vapor transmission rate being measured in accordance with JIS K7129 B (1992) using a film of the third resin having a thickness of 100 μm, and
the layered film has a ratio of a sum of a thickness of the first layer and a thickness of the third layer relative to a thickness of the second layer falling within a range of 1 or more and 4 or less.

2. The layered film according to claim 1, wherein one or both of the first resin and the third resin have an impact strength of 3×10⁻² J or more, the impact strength being measured using a film thereof having a thickness of 100 μm.

3. The layered film according to claim 1, wherein the glass transition temperatures of one or both of the first resin and the third resin are 150° C. or higher.

4. The layered film according to claim 1, wherein the layered film has a thickness of 50 μm or less.

5. The layered film according to claim 1, wherein one or both of the first resin and the third resin contain a polymer having an alicyclic structure.

6. The layered film according to claim 1, wherein the second resin contains a polymer having an alicyclic structure.

7. The layered film according to claim 1, having a light transmittance at a wavelength of 380 nm being 3% or less.

8. A polarizing plate comprising a polarizer and the layered film according to claim 1.
